(19) United States
(12) Patent Application Publication
(10) Pub. No.: US 2020/0139968 A1
(43) Pub. Date: May 7, 2020

(54) VEHICLE CONTROL DEVICE

(71) Applicant: TOYOTA JIDOSHA KABUSHIKI KAISHA, Toyota-shi (JP)

(72) Inventors: Soichi OKUBO, Okazaki-shi (JP); Takashi MAEDA, Nagoya-shi (JP); Tsunekazu YASOSHIMA, Nagoya-shi (JP); Masayuki HOSOKAWA, Nisshin-shi (JP); Yuki TEZUKA, Miyoshi-shi (JP)

(73) Assignee: TOYOTA JIDOSHA KABUSHIKI KAISHA, Toyota-shi (JP)

(21) Appl. No.: 16/522,010

(22) Filed: Jul. 25, 2019

(30) Foreign Application Priority Data
Nov. 1, 2018 (JP) 2018-206537

(51) Int. Cl. B60W 30/18; B60W 10/04

(52) U.S. Cl. CPC B60W 30/18; B60W 10/04; B60W 2400/00; B60W 2550/146; B60W 2720/106; B60W 2420/42

(57) ABSTRACT

A vehicle control device is configured to calculate a first target acceleration based on first information on a road shape of a travelling road when a first situation has been occurring, and calculate a second target acceleration based on second information obtained separately from the first information when a second situation has been occurring. The first situation occurs when the first information indicates that the traveling road is in a curved section. The second situation occurs when the second information indicates that the traveling road is in the curved section. The vehicle control device controls the vehicle, when both situations of the first situation and the second situation have been occurring, such that an actual acceleration approaches a higher priority target acceleration with a higher priority between the first target acceleration and the second target acceleration.

### BACKGROUND

### Technical Field

The present disclosure relates to a vehicle control device configured to control an actual acceleration of a vehicle based on a target acceleration for a curve on which the vehicle travels.

### Related Art

Hitherto, there has been known a vehicle control device configured to determine (calculate) the target acceleration of the vehicle using two methods different from each other when the vehicle travels on the curve. For example, a vehicle control device (hereinafter, referred to as a “convention device”) disclosed in Japanese Patent Application Laid-open No. 2009-51487 determines the target acceleration using the following first and second methods.

First method: The target acceleration is determined based on navigation information provided by a navigation system.

Second method: The target acceleration is determined based on an actual yaw rate of the vehicle, detected by a yaw rate sensor.

Hereinafter, the target acceleration determined according to the first method is referred to as a “first method acceleration”, and the target acceleration determined according to the second method is referred to as a “second method acceleration”.

The conventional device selects a target acceleration between the first method acceleration and the second method acceleration, whichever is smaller (lower), and controls an actual acceleration of the vehicle using the selected target acceleration.

The target acceleration determined/used when the vehicle travels on the curve is typically a negative acceleration, in other words, a positive deceleration.

### SUMMARY

A magnitude of a difference between the first method acceleration and an ideal target acceleration for an actual curve tends to be larger than a magnitude of a difference between the second method acceleration and the ideal target acceleration. In other words, the first method acceleration tends not to be appropriate/suitable for the actual curve, as compared with the second method. The reasons for this are as follows.

An error/difference between a position/location of the curve stored in the navigation system in advance and a position/location of the actual curve is sometimes great (or unignorable). An error/difference between a shape of the curve stored in the navigation system in advance and a shape of the actual curve is sometimes great (or unignorable).

An error/difference between the present position/location of the vehicle which the conventional device specifies/obtains based on the GPS signal received under a poor/bad signal reception condition and the actual present position/location of the vehicle is sometimes great (or unignorable).

However, the conventional device controls the vehicle using the first method acceleration as the target acceleration when the first method acceleration is smaller than the second method acceleration. In this case, when the magnitude of a difference between the first method acceleration and the ideal acceleration is great, the actual acceleration of the vehicle may become an unsuitable acceleration for the actual curve. Such an unsuitable acceleration may cause the driver's discomfort.

The present disclosure has been made to solve the problem described above. The present disclosure has an object to provide a vehicle control device for controlling the vehicle such that the vehicle travels on the curve using the target acceleration which has a higher possibility of being suitable for the curve.

A vehicle control device (hereinafter, may be referred to “the present disclosure device”) comprises:

a first sensor (13, 17, 18) configured to obtain first information on a road shape of a traveling road on which a vehicle is traveling;

a second sensor (11, 12, 16, 19) configured to obtain second information on the road shape separately from the first sensor; and

a control device (10, 20, 30, Steps 425 through 435) configured to:

calculate a first target acceleration which is a target acceleration used when the vehicle travels in a curved section of the traveling road based on the first information (Step 415, Step 540), in a case where a first situation has been occurring, wherein the first situation occurs when the first information indicates that the traveling road is in the curved section (“Yes” at Step 530, “No” at Step 545); and

calculate a second target acceleration which is a target acceleration used when the vehicle travels in the curved section of the traveling road based on the second information (Steps 420, Step 635), in a case where a second situation has been occurring, wherein the second situation occurs when the second information indicates that the traveling road is in the curved section (“Yes” at Step 625, “No” at Step 640).

The control device is configured to:

control the vehicle, when only either one situation of the first situation and the second situation has been occurring (“Yes” or “No” at Step 730), such that an actual acceleration of the vehicle approaches one of the target accelerations which is calculated when the only either one situation has been occurring (Step 740, Step 755); and

control the vehicle, when both situations of the first situation and the second situation have been occurring (“Yes” at Step 715), such that the actual acceleration approaches a higher priority target acceleration with a higher priority between the first target acceleration and the second target acceleration (Step 725).

The present disclosure device controls the actual acceleration of the vehicle VA based on “one of the target accelerations with the higher priority (i.e., higher priority target acceleration)” between the first target acceleration and the second target acceleration, when both the first situation and the second situation have been occurring (in other words, when a situation where both of the first target acceleration and the second target acceleration can be calculated has been occurring). In the present disclosure device, it is possible that a higher priority has been given to the first target acceleration if a magnitude of a difference between the first target acceleration and the ideal target acceleration for the curve is smaller than a magnitude of a difference between the second target acceleration and the ideal target acceleration for the curve. On the other hand, in the present disclosure device, it is possible that a higher priority has been given to the second target acceleration if the magnitude of the difference between the second target acceleration and the ideal target acceleration for the curve is smaller than the magnitude of the difference between the first target acceleration and the ideal target acceleration for the curve. Hereby, the present disclosure device can control the vehicle based on a more suitable target acceleration which is likely to be closer to the ideal acceleration between the first target acceleration and the second target acceleration. Therefore, the present disclosure device can reduce the possibility of causing the driver to feel discomfort when the vehicle travels on the curve.

In one embodiment of the present disclosure,

the first sensor is configured to obtain image data by photographing an front area ahead of the vehicle to obtain the first information using the obtained image data (13), and

the second sensor is configured to detect a physical value indicative of a movement state of the vehicle to obtain the second information using the detected physical value.

Generally, the information (e.g., a curvature representing the road shape of the curve) on the road shape included in the second information obtained using the actually detected physical value (i.e. a yaw rate) indicative of the movement state of the vehicle is more accurate than the information on the road shape included in the first information obtained using the image data. Therefore, in the above embodiment, the second target acceleration calculated based on the second information is likely to be closer to the ideal acceleration than the first target acceleration calculated based on the first information.

Accordingly, in the above embodiment, the control device is configured to have set priorities of the first target acceleration and the second target acceleration such that the priority of the second target acceleration is higher than the priority of the first target acceleration (Step 725). Hereby, according to the above embodiment, the vehicle can travel on the curve using the target acceleration (i.e., second target acceleration) which is likely to be more suitable for the actual curve than the other target acceleration (i.e., first target acceleration).

In one embodiment of the present disclosure,

the first sensor is configured to obtain the first information using map data including information on the road shape (17, 18), and

the second sensor is configured to detect a physical value indicative of a movement state of the vehicle to obtain the second information using the detected physical value (11, 12).

Generally, the information (e.g., a curvature representing the road shape of the curve) on the road shape included in the second information obtained using the actually detected physical value (i.e. a yaw rate) indicative of the movement state of the vehicle is more accurate than the information on the road shape included in the first information obtained using the map data. Therefore, in the above embodiment, the second target acceleration calculated based on the second information is likely to be closer to the ideal acceleration than the first target acceleration calculated based on the first information.

Accordingly, in the above embodiment, the control device is configured to have set priorities of the first target acceleration and the second target acceleration such that the priority of the second target acceleration is higher than the priority of the first target acceleration (Step 725). Hereby, according to the above embodiment, the vehicle can travel on the curve using the target acceleration (i.e., second target acceleration) which is likely to be more suitable for the actual curve than the other target acceleration (i.e., first target acceleration).

In the above cases (in the case where the control device obtains the first information using any one of the image data and the map data and the second information using the physical value indicative of the movement state of the vehicle),

the first sensor is configured to obtain information on the road shape of the traveling road at a position a predetermined distance away from a present position of the vehicle as the first information (Step 515), and

the second sensor is configured to obtain information on the road shape of the traveling road at the present position as the second information (Step 615).

In this case, the first information includes the information on the road shape at a position (hereinafter, referred to as “a future position”) a predetermined distance away from the present position of the vehicle. Therefore, when the future position becomes a position included in the curve before the vehicle enters the curve actually, the first information indicates that the travel road is the curve. Hereby, only the first situation between the first situation and the second situation starts to occur, so that the first target acceleration starts to be calculated, before the vehicle enters the curve from a straight section. Consequently, the vehicle starts to be controlled based on the first target acceleration. As described above, the first target acceleration typically is a negative acceleration (that is, a deceleration). Therefore, the vehicle starts decelerating immediately before the vehicle enters the curve actually. This deceleration can notify the driver of a fact that the vehicle will enter the curve shortly, in advance.

In the above embodiment,

the control device is configured to;

calculate the first target acceleration when only the first situation between the first situation and the second situation has been occurring; and

stop calculating the first target acceleration (Step 545 in a first modification example) and calculate the second target acceleration (Step 635) when both of the first situation and the second situation have been occurring.

The priority set/given to the second target acceleration is higher than the priority set/given to the first target acceleration. Hereby, when the situation has been occurring where both of the first target acceleration and the second target acceleration can be calculated, the vehicle is controlled such that the actual acceleration of the vehicle approaches the second target acceleration. In this case, the first target acceleration is not used for controlling the vehicle. Accordingly, when the situation has been occurring where both of the first target acceleration and the second target acceleration can be calculated, the control device stops calculating the first target acceleration which is not used for controlling the vehicle. Therefore, a processing load of the vehicle control device can be reduced.

In one embodiment of the present disclosure,

the control device is configured to:

calculate a transition time period target acceleration by making a weight of one target acceleration, which the actual acceleration is controlled to approach immediately before a switch time point, between the first target acceleration and the second target acceleration smaller and making a weight of the other target acceleration larger, as an elapsed time from the switch time point becomes longer (Step 840), during a transition time period (“Yes” at Step 835) from the switch time point to a time point at which a predetermined time period elapses from the switch time point,
the switch time point being a time point at which a control state is switched from a first state where the actual acceleration is controlled to approach the one target acceleration to a second state where the actual acceleration is controlled to approach the other target acceleration (“Yes” at Step 810); and

control the vehicle such that the actual acceleration approaches the transition time period target acceleration during the transition time period (Step 435).

Immediately after a switch time point at which the target acceleration switches between the first target acceleration and the second target acceleration, the actual acceleration of the vehicle may change suddenly if the vehicle is controlled such that the actual acceleration approaches the switched target acceleration (when there is a great difference between the first target acceleration and the second target acceleration). Such a sudden change in the actual acceleration of the vehicle may cause the driver to have uncomfortable feeling.

In view of the above, the embodiment calculates the transition time period target acceleration during the transition time period from the switch time point to the time point at which the predetermined time period elapses from the switch time point. The transition time period target acceleration is calculated by making the weight of one of the target accelerations used before the switch time point smaller and making the weight of the other of the target accelerations larger, as the elapsed time from the switch time point becomes longer, during the transition time period. Therefore, the target acceleration used for controlling the vehicle is prevented from changing suddenly and greatly, so that the actual acceleration of the vehicle can be prevented from changing suddenly and greatly.

In one embodiment of the present disclosure,

the control device is configured to:

calculate a first reliability degree indicative of a reliability degree of the first target acceleration (Step 510); and

calculate a second reliability degree indicative of a reliability degree of the second target acceleration (Step 610).

Furthermore, the control device is configured to:

control the vehicle such that the actual acceleration approaches the higher priority target acceleration between the first target acceleration and the second target acceleration (Step 725), when the reliability degree of the higher priority target acceleration is equal to or higher than a first threshold reliability degree (“Yes” at Step 720) in the case where both of the first situation and the second situation have been occurring (“Yes” at Step 715); and

control the vehicle such that the actual acceleration approaches a lower priority target acceleration other than the higher priority target acceleration between the first target acceleration and the second target acceleration (Step 740), when the reliability degree of the higher priority target acceleration is lower than the first threshold reliability degree, and the reliability degree of the lower priority target acceleration is equal to or higher than a second threshold reliability degree in the case where both of the first situation and the second situation have been occurring (“Yes” at Step 735).

According to the above embodiment, even in the case where both of the first target acceleration and the second target acceleration can be calculated, the higher priority acceleration is not used for controlling the vehicle when the reliability degree of the higher priority acceleration is low. In this case, when the reliability degree of the lower priority acceleration is high, the vehicle is controlled such that the actual acceleration of the vehicle approaches the lower priority acceleration. Hereby, the actual acceleration of the vehicle is controlled using the target acceleration having the reliability degree higher than a certain degree. Therefore, the possibility that the vehicle is controlled using the target acceleration which is unsuitable for the curve can be reduced.

In the above description, in order to facilitate the understanding of the disclosure, reference symbols used in embodiment of the present disclosure are enclosed in parentheses and are assigned to each of the constituent features of the disclosure corresponding to the embodiment. However, each of the constituent features of the disclosure is not limited to the embodiment as defined by the reference symbols. Other objects, other features, and accompanying advantages of the present disclosure can be readily understood from a description of the embodiments of the present disclosure provided referring to the accompanying drawings.

### BRIEF DESCRIPTION OF THE DRAWINGS

FIG. 1 is a schematic system configuration diagram of a vehicle control device (the present control device) according to an embodiment.

FIG. 2 is a diagram illustrating an operation of the present control device when a vehicle travels on a curve,

FIG. 3 is graphs illustrating changes of curvatures and target accelerations.

FIG. 4 is a flowchart illustrating a routine executed by a CPU of a driving support ECU (DSECU) illustrated in FIG. 1.

FIG. 5 is a flowchart illustrating a routine which the CPU executes through a process for calculating the first target acceleration which is illustrated in FIG. 4.

FIG. 6 is a flowchart illustrating a routine which the CPU executes through a process for calculating the second target acceleration which is illustrated in FIG. 4.

FIG. 7 is a flowchart illustrating a routine which the CPU executes through a process for determining a speed management (SPM) final target acceleration which is illustrated in FIG. 4.

FIG. 8 is a flowchart illustrating a routine which the CPU executes through a gradual change process which is illustrated in FIG. 4.

### DETAIL DESCRIPTION

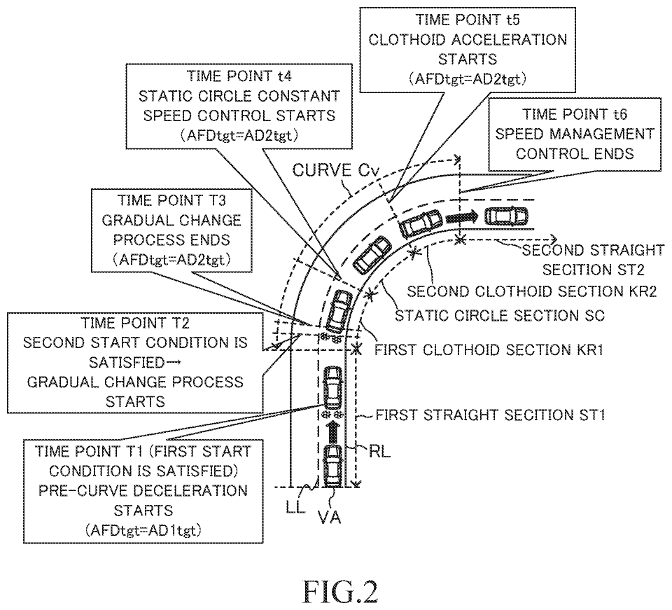

A vehicle control device (hereinafter, referred to as “a present control device”) according to an embodiment of the present disclosure will next be described with reference to the accompanying drawings. The present control device is installed in a vehicle VA shown in FIG. 2.

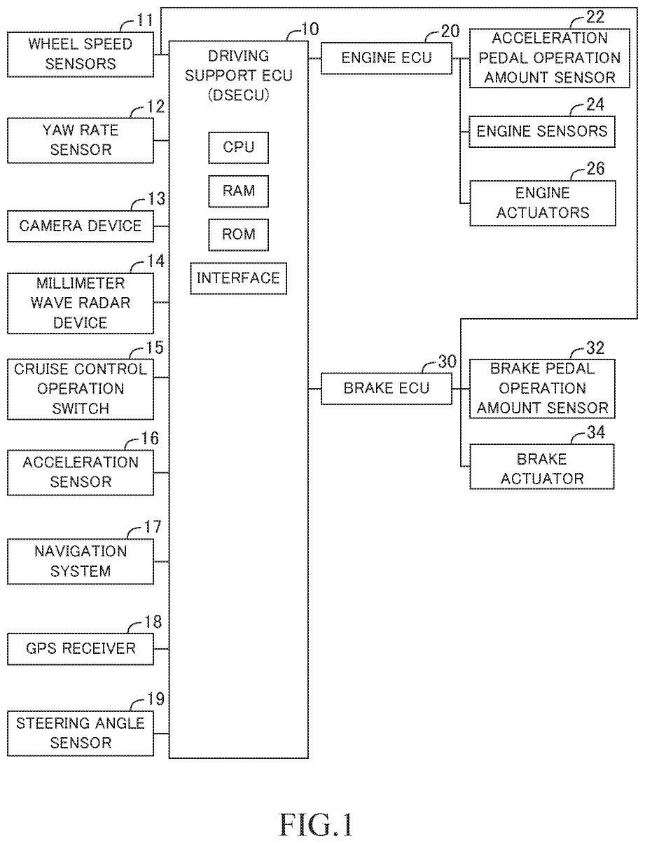

As shown in FIG. 1, the present control device comprises a driving support ECU (hereinafter, referred to as the “DSECU”) 10, an engine ECU 20, and a brake ECU 30. The above ECUs are connected to each other via an unillustrated a controller area network (CAN) to be able to mutually transmit and receive information to/from those ECUs.

In the present specification, the ECU is an abbreviation of an “Electronic Control Unit”. The ECU is an electronic control circuit which includes a microcomputer having a CPU, a ROM, a RAM, an interface I/F, and the like as a main component. The CPU achieves various functions through executing instructions (routines) stored in the ROM. Some or all of those ECUs may be integrated into a single ECU.

The present control device comprises a plurality of wheel speed sensors 11, a yaw rate sensor 12, a camera sensor 13, a millimeter wave radar device 14, a cruise control operation switch 15, an acceleration sensor 16, a navigation system 17, a GPS receiver 18, and a steering angle sensor 19. Those are connected to the DSECU 10. The navigation system 17, the GPS receiver 18, and the steering angle sensor 19 are used by a vehicle control device according to a second modification example described later. Therefore, the navigation system 17, the GPS receiver 18, and the steering angle sensor 19 will be described later in detail.

The wheel speed sensors 11 are provided for wheels of the vehicle VA, respectively. Each of the wheel speed sensor 11 generates one pulse signal (a wheel pulse signal), when the corresponding wheel rotates by a predetermined angle. The DSECU 10 counts the number of the pulse signals transmitted by each wheel speed sensor 11 for/within a predetermined time, and calculates a rotation speed (a wheel speed) of the corresponding wheel based on the counted number of the pulse signals. The DSECU 10 calculates a vehicle speed Vs indicative of a speed of the vehicle VA based on the rotation speeds of the wheels. For example, the DSECU 10 calculates the average of the rotation speeds of the four wheels as the vehicle speed Vs.

The yaw rate sensor 12 detects a yaw rate Yr applied to the vehicle VA to transmit a signal indicative of the detected yaw rate Yr.

The camera device 13 is arranged at the upper part of an windshield in a cabin. The camera device 13 obtains image data of an image (a camera image) of a front area of the vehicle VA to obtain object information, white line information on a white line (a lane marker) which defines (segment the road into) a lane on which the vehicle travels, and the like. The object information includes a distance to an obstacle, a direction of the obstacle, and the like.

The millimeter wave radar device 14 comprises a millimeter wave transmission and reception unit and a processing unit. The millimeter wave radar device 14 is arranged at a center position of a front end in a vehicle width direction. The millimeter wave transmission and reception unit transmits a millimeter wave which spreads to an area with a predetermined angle in a right direction and a left direction from a center axis extending in a forward direction of the vehicle VA. The object (e.g. an other vehicle, a pedestrian, a two-wheeled vehicle (a motorcycle, or a bicycle), or the like) reflects the transmitted millimeter wave. The millimeter transmission and reception unit receives such a reflected wave.

The processing unit of the millimeter wave radar device 14 obtains a distance to the object, a relative speed Vfx(n) of the object in relation to the vehicle VA, a direction of the object in relation to the vehicle VA, and the like as object information. If the object is the other vehicle, the distance to the other vehicle may be referred to as a distance between two vehicles Dfx(n). The direction of the object in relation to the vehicle VA is an angle between “a straight line passing through a position of the object and a position of the millimeter wave transmission and reception unit of the millimeter wave radar device 14” and the above described center line.

More specifically, the processing unit obtains the object information based on a time period from a time point at which the millimeter wave is transmitted to a time point at which the reflected wave of the millimeter wave is received, an attenuation level of the reflected wave, a phase difference between the transmitted millimeter wave and the received reflected wave, and the like.

The DSECU 10 obtains final object information which is used though a cruise control described later by modifying the object information obtained by the millimeter wave radar device 14 based on the object information obtained by the camera device 13.

The cruise control operation switch 15 is a switch which a driver operates when the driver wants to start the cruise control. When the driver operates the cruise control operation switch 15, the cruise control operation switch 15 transmits a start signal indicating that the driver operates the cruise control operation switch 15 to the DSECU 10.

Furthermore, the driver operates the cruise control operation switch 15 in order to change/set “a target time period between two vehicles Ttgt” which is used through an adaptive cruise control (ACC) described later, and a target vehicle speed which is used through a cruise control.

The acceleration sensor 16 detects an acceleration in a longitudinal direction (a front-rear direction) of the vehicle VA, and an acceleration (hereinafter, referred to as a “lateral acceleration LG”) in a lateral direction (in the vehicle width direction) to transmit a detection signal indicative of the detected accelerations to OSECU 10.

The engine ECU 20, which is connected to an acceleration pedal operation amount sensor 22 and engine sensors 24, receives a detection signal transmitted by those sensors.

The acceleration pedal operation amount sensor 22 detects an operation amount (an acceleration pedal operation amount AP) of an acceleration pedal (an accelerator) (not shown) of the vehicle VA. The acceleration pedal operation amount AP is “0” when the driver does not operate the acceleration pedal.

The engine sensors 24 detect various drive state amounts of “a gasoline-fuel injection, spark-ignition-type, and multi-cylinder engine which is a driving source of the vehicle VA”. For example, the engine sensors 24 are a throttle valve opening degree sensor, an engine rotation speed sensor, and an air intake sensor.

Furthermore, the engine ECU 20 is connected to engine actuators 26. For example, the engine actuators 26 are a throttle valve actuator and a fuel injection valve actuator. The engine ECU 20 adjusts driving force applied to the vehicle VA by changing torque generated by the engine through driving the engine actuator 52.

The engine ECU 20 determines a target throttle valve opening degree TAtgt in such a manner that the throttle valve opening degree TAtgt becomes larger as the acceleration pedal operation amount AP becomes larger. The engine ECU 20 drives the throttle valve actuator in such a manner that the throttle valve opening degree coincides with the target throttle valve opening degree TAtgt.

The brake ECU 30, which is connected to the wheel speed sensors 11 and a brake pedal operation amount sensor 32, receives a detection signal transmitted by those sensors.

The brake pedal operation amount sensor 32 detects an operation amount (a brake pedal operation amount BP) of a brake pedal (not shown) of the vehicle VA. The brake pedal operation amount BP is “0” when the driver not operate the brake pedal.

The brake ECU 30 calculates the rotation speeds of the wheels and the vehicle speed Vs based on the wheel pulse signals transmitted by the wheel speed sensors 11, like the DSECU 10. In some embodiments, the brake ECU 30 may obtain, from the DS ECU 10, the rotation speeds of the wheels and the vehicle speed Vs which are calculated by the DSECU 10. In this case, the brake ECU 30 needs not to be connected to the wheels sensors 11.

The brake ECU 30 is connected to a brake actuator 34 which is a hydraulic control actuator. The brake actuator 34 is provided in a hydraulic circuit arranged at a position between a master cylinder (not shown) and a friction brake device (not shown). The master cylinder pressurizes working oil by using a depressing force applied to the brake pedal. The frictional brake device includes well-known wheel cylinders. Each of the wheel cylinders is arranged in the corresponding wheels. The brake actuator 34 adjusts oil pressure applied to each wheel cylinder to adjust brake force of the vehicle VA.

The brake ECU 30 determines a target acceleration GBPtgt with a negative value, that is a deceleration with a positive value, based on the brake pedal operation amount BP. The brake ECU 30 drives the brake actuator 34 in such a manner that an actual acceleration of the vehicle coincides the target acceleration.

(Detail Description of Vehicle Control)

1. Cruise Control (ACC)

The DSECU 10 executes, as the cruise control, either one of a distance maintaining control and a constant speed traveling control.

1.1: ACC Target Acceleration for the Distance Maintaining Control

The DSECU 10 determines/specifies an other vehicle ahead (in front) of the vehicle VA (hereinafter, referred to as “an objective-forward-vehicle or a follow-updd vehicle ahead (a)”) which the vehicle VA follows (i.e., trails), according to a well-known method disclosed in Japanese Patent Application Laid-open No. 2015-072604. The DSECU 10 calculates a target distance Dtgt between the vehicle VA and the objective-forward-vehicle (a) by multiplying a target time period Ttgt by the vehicle speed Vs. The driver sets the target time period Ttgt to a driver's desired value by operating the cruise control operation switch 15. Notably, however, the target time period Ttgt may be a fixed value.

The DSECU 10 calculates a deviation distance ΔD1 (=Dfx(a)−Dtgt) by subtracting the target distance Dtgt from the distance Dfx(a) between the objective-forward-vehicle (a) and the vehicle VA. The DSECU 10 calculates an ACC target acceleration GACCtgt by applying the deviation distance ΔD1 to the following equation (1). In the equation (1), Vf(x) represents a relative speed of the objective-forward-vehicle (a). Furthermore, in the equation (1), each of Ka1, K1, and K2 represents a predetermined gain (coefficient).

GACCtgt=Ka1*(K1*ΔD1+K2*Vfx(a)) (1)

1.2: ACC Target Acceleration for the Constant Speed Traveling Control

When the DSECU 10 detects no objective-forward-vehicle (a), the DSECU 10 controls an acceleration of the vehicle VA in such a manner that the vehicle speed Vs of the vehicle VA coincides with (or becomes equal to) the target vehicle speed for the constant speed traveling control. For example, the driver sets the target vehicle speed for the constant speed traveling control to a driver's desired value by operating the cruise control operation switch 15. When the vehicle speed Vs is lower than the target vehicle speed, the DSECU 10 increases the ACC target acceleration GACCtgt gradually by a predetermined amount ΔG in a predetermined time period. When the vehicle speed Vs is higher than the target vehicle speed, the DSECU 10 decreases the ACC target acceleration GACCtgt gradually by a predetermined amount ΔG in a predetermined time period.

1.3: Execution of ACC

The DSECU 10 transmits the ACC target acceleration GACCtgt calculated in the above described manner to the engine ECU 20 and the brake ECU 30 as a driving support target acceleration GStgt.

The engine ECU 20 increases or decreases the target throttle valve opening degree TAtgt in such a manner that an actual acceleration (hereinafter, simply referred to as “an actual acceleration dg”) in the longitudinal direction of the vehicle VA coincides with the driving support target acceleration GStgt. Furthermore, the brake ECU 30 controls the brake force using the brake actuator in such a manner that the actual acceleration dg of the vehicle VA coincides with the driving support target acceleration GStgt to decelerate the vehicle, when the actual acceleration dg is larger than the driving support target acceleration GStgt after the target throttle valve opening degree TAtgt becomes “0 (the minimum value)”. The brake ECU 30 determines/adopts either one of a target acceleration corresponding to the brake pedal operation amount BP and the driving support target acceleration GStgt, whichever is smaller, as a final target acceleration. Thereafter, the brake ECU 30 controls the brake actuator 34 based on the determined target acceleration. In other words, the brake ECU 30 is configured to execute a brake override.

As described above, the engine ECU 20 determines the target throttle valve opening degree TAtgt based on the acceleration pedal operation amount AP. When the target throttle valve opening degree TAtgt determined based on the acceleration pedal operation amount AP is larger than the target throttle valve opening degree TAtgt determined through the cruise control (determined based on the driving support target acceleration GStgt), the engine ECU 20 controls an actual throttle valve opening degree TA based on the target throttle valve opening degree TAtgt determined based on the acceleration pedal operation amount AP. In other words, the engine ECU 20 is configured to execute an acceleration override.

2: Speed Management Control

When the vehicle VA is traveling on a curve while the DSECU 10 is executing the cruise control, the DSECU 10 controls the vehicle speed Vs by adjusting the acceleration of the vehicle VA so that the vehicle VA can travel on the curve stably. Such a control is a speed management control.

More specifically, the DSECU 10 calculates two target accelerations which are to be used for controlling the vehicle speed Vs according to two different methods. That is, the DSECU 10 calculates a first target acceleration according to a first method and a second target acceleration according to a second method.

In the first method, the DSECU 10 obtains first information on a shape of a traveling road on which the vehicle VA is traveling to determine whether or not “a first situation/state that the first information represents that the traveling road is a curve” has occurred. In response to the occurrence of the first situation, the DSECU 10 calculates, as the first target acceleration, a target value of the acceleration in a case where the vehicle VA travels on the curve.

In the second method, the DSECU 10 obtains second information on the shape on the traveling road separately from the first information to determine whether or not “a second situation that the second information represents that the traveling road is a curve” has occurred. In response to the occurrence of the second situation, the DSECU 10 calculates, as the second target acceleration, the target value of the acceleration in a case where the vehicle VA travels on the curve.

As described later, the vehicle speed Vs controlled based on the second target acceleration tends to be (has a higher possibility of being) a more suitable value for the actual curve than the vehicle speeds Vs controlled based on the first target acceleration. In other words, the second target acceleration has a high possibility of being an acceleration reflecting the shape of the curve more accurately than the first target acceleration. On the other hand, as described later, when the vehicle VA enters the curve, the first target acceleration starts to be calculated at an earlier timing than the second target acceleration. In addition, the first target acceleration starts to be smaller earlier than the second target acceleration. That is, both of the first target acceleration and the second target acceleration are equal to or smaller than “0”, however, a time point at which a magnitude of the first target acceleration becomes a value larger than “0” is earlier than a time point at which a magnitude of the second target acceleration becomes a value larger than “0”. The time point at which the magnitude of the target acceleration becomes the value larger than the “0” means a time point at which the DSECU 10 starts calculating the target acceleration. Meanwhile, when the DSECU 10 can obtain no basic data (e.g. a curvature of the curve) used for calculating the first target acceleration for any reason, the DSECU 10 calculates only the second target acceleration.

When the DSECU 10 calculates only one of the first target acceleration and the second target acceleration, the DSECU 10 controls the vehicle VA in such a manner that the actual acceleration dg of the vehicle VA approaches the calculated target acceleration. In other words, when only one of a first situation that the first information represents that the traveling road is the curve and a second situation that the second information represents that the traveling road is the curve has occurred, the DSECU 10 controls the actual acceleration dg based on “the only one target acceleration among the first target acceleration and the second target acceleration” which is calculated when the only one situation of the first situation and the second situation has occurred.

When the DSECU 10 calculates both the first target acceleration and the second target acceleration, the DSECU 10 controls the vehicle VA such that the actual acceleration dg of the vehicle VA approaches either one of the first target acceleration and the second target acceleration, whichever has higher priority. In the present embodiment, the second target acceleration has been set to have a higher priority than the first target acceleration, because the second target acceleration has a higher possibility of being more suitable value for the actual curve than the first target acceleration. That is, when both the first situation and the second situation have been occurring, the DSECU 10 controls the actual acceleration dg based on the second target acceleration having the higher priority. The following describes the first method for calculating the first target acceleration and the second method for calculating the second target acceleration.

2.1: First Method

The DSECU 10 adopts a white line recognition method as the first method. More specifically, the DSECU 10 specifies (recognizes) two lane markers which define (segment the road into) the lane (self-lane, currently-running-road) in which the vehicle is traveling based on the camera image (the image data) obtained by the camera device 13. The two lane markers include a left white line (referring to FIG. 2) and a right white line (referring to FIG. 2). The DSECU 10 obtains, as future information, information on the shape of the road at a position (hereinafter, referred to as “a future position”) a predetermined distance D away from the present position of the vehicle VA in a travel direction. More specifically, the DSECU 10 obtains, as a future curvature FC, a curvature C of a virtual line at the future position. The virtual line is a line which passes through a center between the left white line LL and the right white line RL in the lane (or vehicle) width direction. The information on the shape of the road includes the curvature C of the road at the future position. The curvature C of the road at the future position may be referred to as the future curvature FC. The future information is information for enabling the DSECU 10 to specify the shape of the road ahead of the position (present position) of the vehicle VA at the present time point. The future information is the above described first information.

The DSECU 10 determines that a start condition (hereinafter, referred to as “a first start condition”) for calculating a first target acceleration AD1tgt becomes satisfied, when the future information satisfies “a condition to be satisfied when the vehicle VA enters the curve”. In other words, the DSECU 10 determines that the first situation is occurring when the first information is indicating that the traveling road is the curve.

Subsequently, the DSECU 10 calculates the first target acceleration AD1tgt for enabling the vehicle VA to travel stably on the curve which the vehicle VA is entering or the vehicle VA has entered, based on the future information (especially, the future curvature) which is the first information.

2.2: Second Method

The DSECU 10 adopts/employs an actual measured value method (a yaw rate method) as the second method. More specifically, the DSECU 10 obtains the present information including a physical value which is measured by a sensor at the present time point and is indicative of a movement state of the vehicle. For example, the physical value is the yaw rate relating to a turning movement of the vehicle VA. The present information is information for enabling the DSECU 10 to specify the shape of the road at the position (present position) of the vehicle VA at the present time point. The present information is the above described second information.

The DSECU 10 determines that a start condition (hereinafter, referred to as “a second start condition”) for calculating the second target acceleration AD2tgt becomes satisfied when the present information satisfies “a condition to be satisfied when the vehicle VA enters the curve”. In other words, the DSECU 10 determines that the second situation is occurring when the second information is indicating that the traveling road is the curve.

Subsequently, the DSECU 10 calculates the second target acceleration AD2tgt for enabling the vehicle VA to travel stably on the curve on which the vehicle VA has entered, based on the present information (especially, the present curvature indicative of a curvature of the road at the present position) which is the second information. The second method is a well-known method which is disclosed, for example, in Japanese Patent Application Laid-open No. 2009-51487.

The magnitude of the yaw rate Yr does not become large at a time point immediately before the vehicle VA enters the curve. Therefore, the second start condition is not satisfied, and thus, the second situation does not occur, at the time point immediately before the vehicle VA enters the curve. In contrast, the future information indicates that the traveling road is the curve at the time point immediately before the vehicle VA enters the curve. Therefore, the first start condition is satisfied, and thus, the first situation occurs, at the time point immediately before the vehicle VA enters the curve. Therefore, only one of the first situation and the second situation (i.e., only the first situation) occurs at the time point immediately before the vehicle VA enters the curve. When only the first start condition has been satisfied, the DSECU 10 calculates the first target acceleration AD1tgt to control the vehicle VA based on the first target acceleration AD1tgt.

While the vehicle VA is traveling on the curve after a time point when the vehicle VA entered the curve, both the first start condition and the second start condition are satisfied (that is, both the first situation and the second situation are occurring). In this case, the DSECU 10 controls the vehicle VA based on the target acceleration (that is, the second target acceleration AD2tgt) which has (with) the higher priority between the first target acceleration AD1tgt and the second target acceleration AD2tgt.

The following describes the reason why the second target acceleration AD2tgt has been set to have the higher priority compared to the first target acceleration AD1tgt. A difference between the shape of the curve specified based on the second method and the actual shape of the curve tends to be smaller than a difference between the shape of the curve specified based on the first method and the actual shape of the curve. Accordingly, a magnitude of a difference between the second target acceleration AD2tgt thus calculated based on the shape of the curve and “an ideal acceleration which is an acceleration at which the vehicle VA can travel on the curve stably” is smaller than a magnitude of a difference between the first target acceleration AD1tgt and the ideal acceleration. In other words, the second target acceleration AD2tgt tends to be more appropriate/suitable for the curve than the first target acceleration AD1tgt. Therefore, the higher priority has been given to the second target acceleration AD2tgt, and the lower priority has been given to to the first target acceleration AD1tgt.

Meanwhile, the time point at which the second start condition becomes satisfied is after the time point at which the vehicle VA has entered the curve actually. Therefore, if the DSECU 10 controls the vehicle VA based only on the second target acceleration AD2tgt, the DSECU 10 cannot decrease the vehicle speed Vs before the vehicle VA actually enters the curve,

In view of the above, the DSECU 10 is configured to control the vehicle VA based on the first target acceleration AD1tgt from the time point at which the DSECU 10 determines that the first start condition becomes satisfied (the first situation has occurred) to start calculating the first target acceleration AD1tgt. The deceleration of the vehicle VA enables the driver to recognize/notice that the vehicle VA is about to enter the curve in advance.

### SPECIFIC EXAMPLE

An example illustrated in FIG. 2 shows that the vehicle VA travels on the road including the curve Cv. In this example, the curve Cv includes the first clothoid (curve) section KR1, the static circular section SC, and the second clothoid (curve) section KR2. The vehicle VA travels/moves on the road in order of a first straight section ST1, the first clothoid section KR1, the static circular section SC, the second clothoid section KR2, and a second straight section ST2.

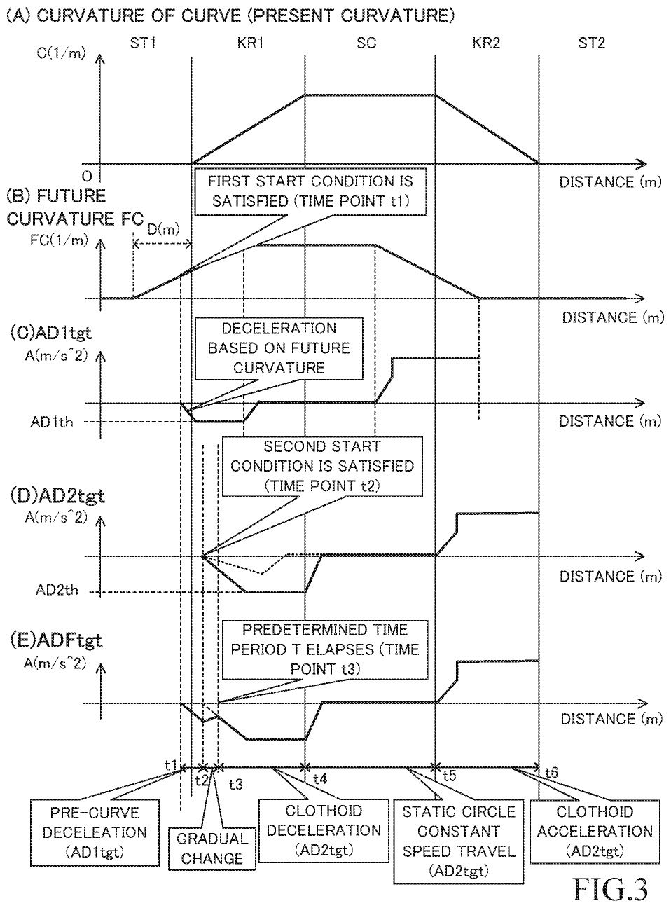

As shown in (A) of FIG. 3, a curvature C of the first clothoid section KR1 included in a typical curve gradually increases in the travelling direction of the vehicle VA, the curvature C of the static circular section SC remains at a constant value, and the curvature C of the second clothoid section KR2 gradually decreases from the constant value in the travelling direction.

The DSECU 10 calculates the future curvature FC (the curvature at the future position) based on the left white line LL and the right white line RL, using the first method. Therefore, the first start condition becomes satisfied at a time point t1 when the vehicle VA reaches a certain position within the first straight section ST1. In other words, the first situation starts occurring at the time point t1. Accordingly, the DSECU 10 determines the first target acceleration AD1tgt as a SPM final target acceleration ADFtgt described later to start the speed management control based on the first target acceleration AD1tgt at the time point t1. At the time point t1, the second start condition is not satisfied, because no yaw rate Yr is generated in the vehicle VA. In other words, the second situation does not occur at the time point t1.

As described in detail later, the first target acceleration AD1tgt becomes larger deceleration (the negative value with larger magnitude) as the vehicle speed Vs becomes higher. Furthermore, the first target acceleration AD1tgt becomes larger deceleration as the future curvature FC becomes larger. When the first target acceleration AD1tgt is the negative value, the vehicle VA starts decelerating at/from the certain position within the first straight section ST1 before the vehicle VA enters the curve Cv (referring to the time point t1 shown in FIG. 2, and, (C) and (E) shown in FIG. 3). Such a deceleration may be referred to as “a pre-curve deceleration”.

When the vehicle VA has just entered the first clothoid section KR1, the driver starts performing a steering operation on a steering handle. Hereby, the vehicle VA starts turning, so that the yaw rare Yr starts to be generated in (applied to) the vehicle VA. Therefore, the second start condition becomes satisfied at a time point t2 when the vehicle reaches a certain position within the first clothoid KR1 (referring to the time point t2 shown in (D) of FIGS. 2 and 3). Accordingly, the second situation starts occurring at the time point t2.

In this case, the DSECU 10 calculates both of the first target acceleration AD1tgt and the second target acceleration AD2tgt because both of the first start condition and the second start condition are satisfied (in other words, because both of the first situation and the second situation have been occurring). Thereafter, the DSECU 10 determines/employs the second target acceleration AD2tgt as the SPM final target acceleration ADFtgt, because the second target acceleration AD2tgt has the higher priority than the first target acceleration AD1tgt.

Accordingly, the SPM final target acceleration ADFtgt switches from the first target acceleration AD1tgt to the second target acceleration AD2tgt at the time point t2. When the SPM final target acceleration ADFtgt switches from the first target acceleration AD1tgt to the second target acceleration AD2tgt, the SPM final target acceleration ADFtgt may greatly change suddenly. Such a sudden great change in the SPM final target acceleration ADFtgt may cause the driver to feel uncomfortable.

In view of the above, the DSECU 10 executes a “gradual change process” during a transition time period (referring to FIG. 2, and, (D) and (E) in FIG. 3) from “the time point t2 when the SPM final target acceleration ADFtgt switches from the first target acceleration AD1tgt to the second target acceleration AD2tgt” to “a time point t3 when a predetermined time T elapse from the time point t2”. The gradual change process is a process for changing the SPM final target acceleration ADFtgt from the first target acceleration AD1tgt to the second target acceleration AD2tgt gradually. Therefore, as shown in (E) of FIG. 3, the SPM final target acceleration ADFtgt changes gradually from the first target acceleration AD1tgt to the second target acceleration AD2tgt during a time period from the time point t2 to the time point t3, so that the SPM final target acceleration ADFtgt coincides with the second target acceleration AD2tgt at the time point t3. In this manner, the gradual change process can prevent the SPM final target acceleration ADFtgt from changing greatly and suddenly, and therefore can prevent the driver from feeling uncomfortable.

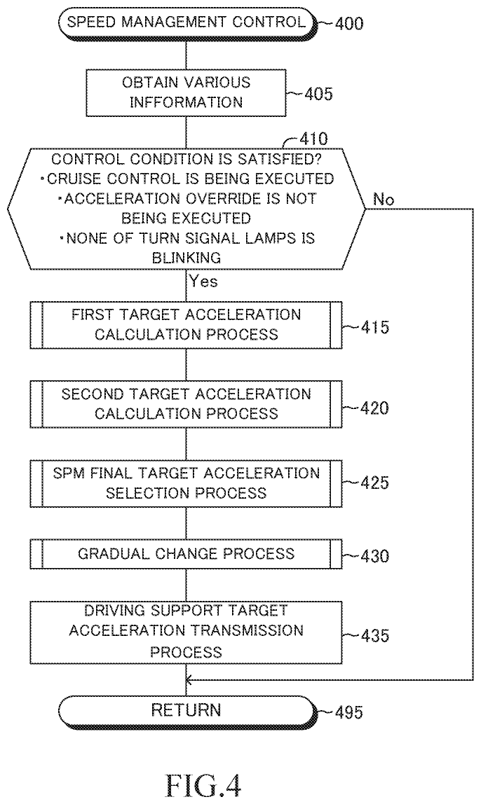

The DSECU 10 determines that the vehicle VA has entered the static circle section SC based on the yaw rate Yr at a time point t4 (referring to FIG. 4) when the vehicle VA has entered the static circle section SC. In this case, the DSECU 10 calculates the second target acceleration AD2tgt for enabling the vehicle VA to travel in the static circle section SC at the constant vehicle speed Vs (referring (D) of FIG. 3). The second target acceleration AD2tgt calculated in a period after the time point t4 is substantially “0”. In the period after the time point t4, the DSECU 10 calculates both of the first target acceleration AD1tgt and the second target acceleration AD2tgt, because both of the first situation and the second situation have been occurring. In this case as well, the DSECU 10 determines/employs the second target acceleration AD2tgt as the SPM final target acceleration ADFtgt based on the above described priorities (referring to (E) of FIG. 3).

In (D) of FIG. 3, a dotted line in a period from the time point t2 to the time point t4 represents the second target acceleration AD2tgt when the vehicle speed Vs reaches a curve target vehicle speed Vctgt described later. On the other hand, a solid line shown in (D) of FIG. 3 in that period represents the second target acceleration AD2tgt when the vehicle speed Vs does not reach the curve target vehicle speed Vctgt. As understood from those lines, even if the vehicle speed Vs does not reach the curve target vehicle speed Vctgt, the vehicle VA is controlled so as to travel at the constant vehicle speed Vs when the vehicle VA enters the static circle section SC.

The DSECU 10 determines that the vehicle VA has entered the second clothoid section KR2 based on the yaw rate Yr at a time point t5 (referring to FIG. 2) when the vehicle VA has entered the second clothoid section KR2. In this case, the DSECU 10 calculates the second target acceleration AD2tgt for enabling the vehicle speed Vs to coincide with a normal target vehicle speed Vntgt (referring to (D) of FIG. 3). The normal target vehicle speed Vntgt, which will be described later in detail, is a target vehicle speed used though the cruise control. The DSECU 10 calculates both of the first target acceleration AD1tgt and the second target acceleration AD2tgt, because both of the first situation and the second situation have been occurring. In this case as well, the DSECU 10 determines/employs the second target acceleration AD2tgt as the SPM final target acceleration ADFtgt based on the above described priorities (referring to (E) of FIG. 3). The second target acceleration AD2tgt calculated after the time point t5 is positive, and therefore, the vehicle speed Vs increases at the second target acceleration AD2tgt in the second clothoid section KR2. Such an acceleration may be referred to as “a clothoid acceleration”.

The DSECU 10 determines that the vehicle VA has entered the second straight section ST2 based on the yaw rate Yr at a time point t6 (referring to FIG. 2) when the vehicle VA has entered the second straight section ST2. That is, the second situation does not occur after the time point t6. Therefore, the DSECU 10 stops calculating the second target acceleration AD2tgt, Hereby, the DSECU 10 terminates/ends the speed management control. It should be noted that the future curvature FC becomes “0” immediately before the time point t6, so that the first situation no longer occurs. Therefore, the DSECU 10 stops calculating the first target acceleration AD1tgt immediately before the time point t6.

(Actual Operation)

1. Speed Management Control Routine

The CPU of the DSECU 10 (hereinafter, the term “CPU” means the CPU of the DSECU 10 unless otherwise specified) is configured to execute a routine (a speed management control routine) represented by a flowchart shown in FIG. 4, every time a predetermined time elapses.

When a predetermined timing has come, the CPU starts processes from Step 400 shown in FIG. 4, and proceeds to Step 405 to read out (obtain) information from various devices and various sensors which are connected to the DSECU 10. Thereafter, the CPU proceeds to Step 410.

At Step 410, the CPU determines whether or not a control condition for starting the speed management control has been satisfied. More specifically, the CPU determines that the control condition has been satisfied when all of the following conditions (B1) through (B3) have been satisfied. The CPU receives a signal indicative of whether or not the engine ECU 20 is executing the acceleration override from the engine ECU 20. Furthermore, the CPU receives a signal indicative of whether or not one of two sets of turn signal lamps (not shown) of the vehicle VA is blinking intermittently from a turn signal lamp control ECU (not shown).

(B1) The cruise control is being executed.

(B2) The acceleration override is not being executed.

(B3) None of the turn signal lamps is blinking.

When at least one of the conditions (B1) through (B3) has not been satisfied, the CPU makes a “No” determination at Step 410, and proceeds to Step 495 to tentatively terminate the present routine. For example, if the condition (B2) has not been satisfied, it is likely that the driver wants to accelerate the vehicle VA by operating an acceleration pedal. Therefore, the CPU does not execute the speed management control. If the condition (B3) has not been satisfied, it is considered that the vehicle VA is likely to turn left or right. Therefore, the CPU does not execute the speed management control.

On the other hand, when all of the conditions (B1) through (B3) have been satisfied, the CPU makes a “Yes” determination at Step 410 to execute the following processes of Step 415 through 435 in order, and proceeds to Step 495 to tentatively terminate the present routine.

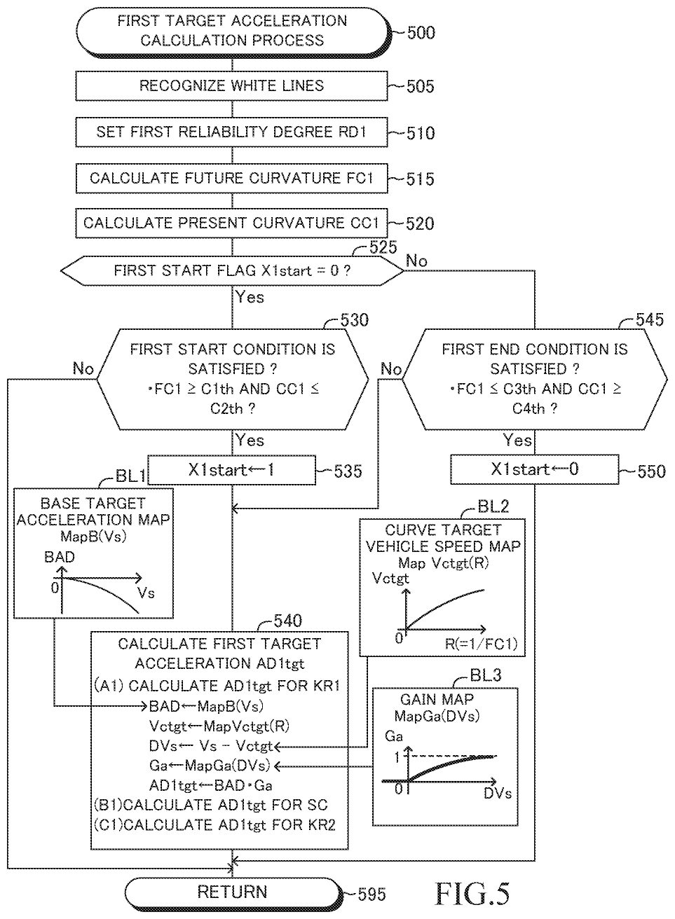

Step 415: The CPU executes a first target acceleration calculation process described later with reference to FIG. 5 to calculate the first target acceleration AD1tgt.

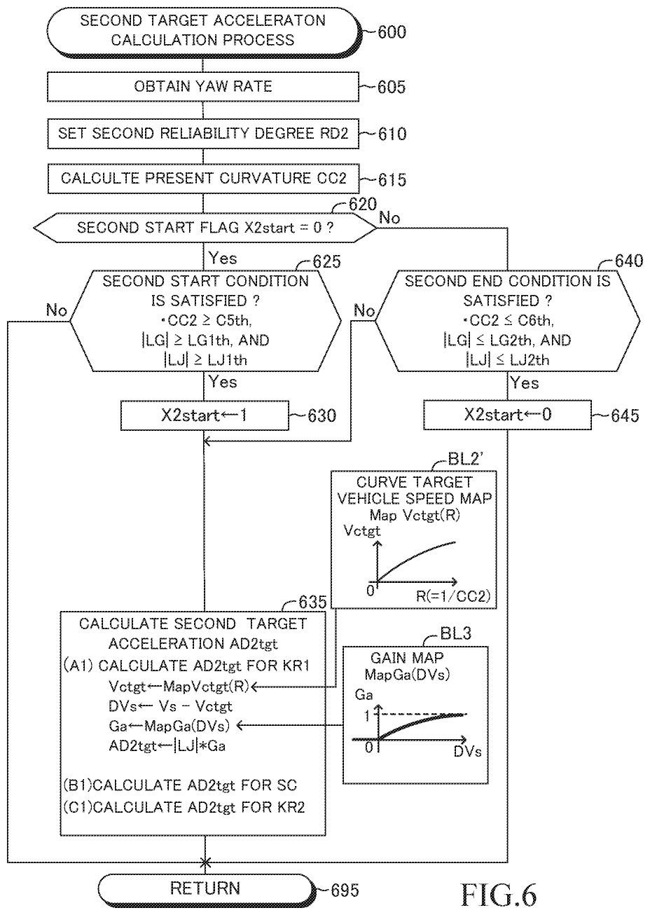

Step 420: The CPU executes a second target acceleration calculation process described later with reference to FIG. 6 to calculate the second target acceleration AD2tgt.

Step 425: The CPU executes a process to select/determine one of the first target acceleration AD1tgt and the second target acceleration AD2tgt as the SPM final target acceleration ADFtgt.

More specifically, when the CPU calculates only one of the first target acceleration AD1tgt and the second target acceleration AD2tgt, the CPU determines/employs the calculated that one target acceleration as the SPM final target acceleration ADFtgt. As described above, when the vehicle VA is approaching the curve, the CPU starts calculating the first target acceleration AD1tgt before the CPU starts calculating the second target acceleration AD2tgt. Therefore, in this case, the CPU determines/employs the first target acceleration AD1tgt as the SPM final target acceleration ADFtgt.

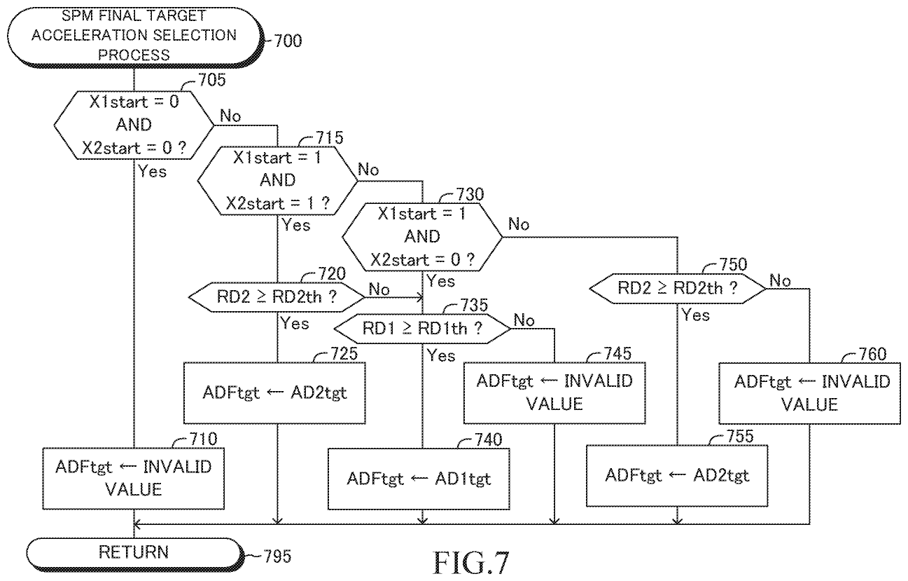

On the other hand, when the CPU calculates both of the first target acceleration AD1tgt and the second target acceleration AD2tgt, the CPU determines/employs the second target acceleration AD2tgt which has (or with) the higher priority than the first target acceleration AD1tgt as the SPM final target acceleration ADFtgt. As described later, for example, when the CPU calculates neither the first target acceleration AD1tgt nor the second target acceleration AD2tgt, the CPU may set the SPM final target acceleration ADFtgt to an invalid value (“null”). The process of Step 425 will be described later in greater detail with reference to FIG. 7.

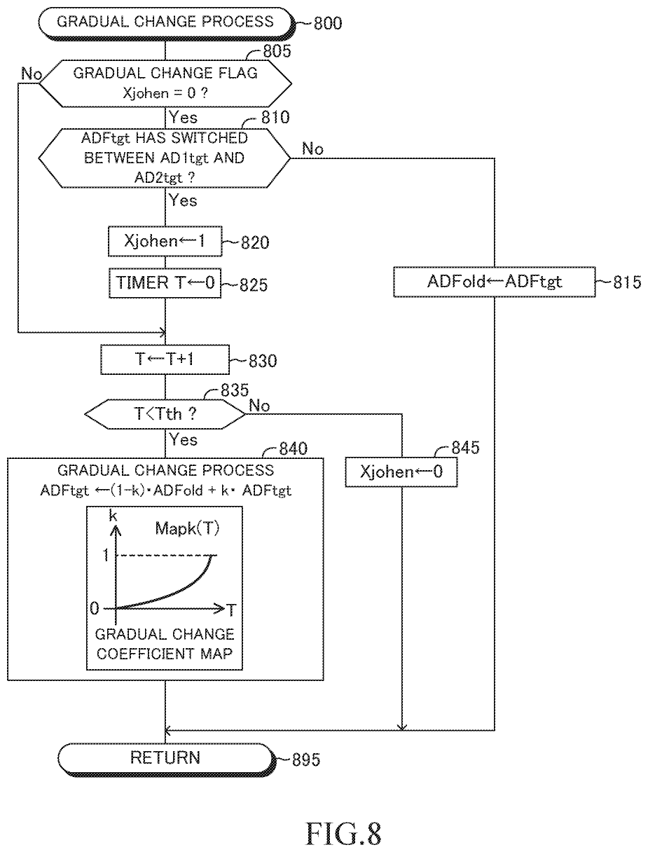

Step 430: The CPU executes the gradual change process when the present time point is in the transition time period in which the gradual change process is required, to determine/employs the target acceleration which is calculated through the gradual change process as the SPM final target acceleration ADFtgt. The process of Step 430 will be described later in greater detail with reference to FIG. 8.

Step 435: The CPU transmits either one of the SPM final target acceleration ADFtgt determined through the processes of Steps 415 through 430 and the above described ACC target acceleration GACCtgt, whichever is smaller, as the driving support target acceleration GStgt to the engine ECU 20 and the brake ECU 30. When the SPM final target acceleration ADFtgt is the invalid value (Null), the CPU transmits the ACC target acceleration GACCtgt as the driving support target acceleration GStgt to the engine ECU 20 and the brake ECU 30.

The engine ECU 20 increases or decreases the target throttle valve opening degree TAtgt in such a manner that the actual acceleration dg in the longitudinal direction of the vehicle VA coincides with (becomes equal to) the driving support target acceleration GStgt transmitted by the DSECU 10. Furthermore, the brake ECU 30 controls the brake force using the brake actuator in such a manner that the actual acceleration dg of the vehicle VA coincides with the driving support target acceleration GStgt to decelerate the vehicle VA, when the actual acceleration dg is larger than the driving support target acceleration GStgt at the time point when the target throttle valve opening degree TAtgt becomes “0”. The brake ECU 30 determines/employs the target acceleration GBPtgt corresponding to either one of “the brake pedal operation amount BP” and “the driving support target acceleration GStgt”, whichever is smaller, as the final target acceleration to control the brake actuator 34 based on that determined/employed target acceleration. That is, the brake ECU 30 is configured to execute the brake override.

<First Target Acceleration Calculation Process (Routine Shown in FIG. 5)>

When the CPU proceeds to Step 415 shown in FIG. 4, the CPU starts processes from Step 500, which are included in a subroutine represented by a flowchart shown in FIG. 5, to execute the following processes of Steps 505 through 520. Thereafter, the CPU proceeds to Step 525.

Step 505: The CPU recognizes (obtains information on) the left white line LL and the right white line RL based on the camera image. The left white line LL is on the left side of a lane (a self-lane) in which the vehicle VA is currently traveling/running. The right white line RL is on the right side of the self-lane. In other words, the left white line LL and the right white line RL are lines which define the self-lane. The process for recognizing the white lines is a well-known process. For example, such a process is disclosed in Japanese Patent Application Laid-open No. 2013-105179.

Step 510: The CPU calculates a first reliability degree RD1 indicative of a reliability of the first target acceleration AD1tgt based on the number of the white lines recognized at Step 505. More specifically, the CPU calculates the first reliability degree RD1 in the manner as described below from (1) through (3).

(1) When the number of the recognized white lines is “0” (in other words, when the CPU can recognize neither the left white line LL nor the right white line RL), the CPU sets the first reliability degree RD1 to “0”.

(2) When the number of the recognized white lines is “1” (in other words, when the CPU can recognize only one of the left white line LL and the right white line RL), the CPU sets the first reliability degree RD1 to “50”,

(3) When the number of the recognized white lines is “2” (in other words, when the CPU can recognize both the left white line LL and the right white line RL), the CPU sets the first reliability degree RD1 to “100”.

As understood from the above, the white line(s) used for calculating the future curvature FC1 and the present curvature CC1 has/have been detected more certainly/accurately, as the first reliability degree RD1 is larger. The difference between the first target acceleration AD1tgt which the CPU calculates using the curvature calculated based on the recognized white line(s) and the ideal acceleration for the curve Cv becomes smaller, as the white line(s) has/have been detected more certainly/accurately.

Step 515: The CPU calculates the future curvature FC1 based on the white line(s) recognized at Step 505.

Step 520: The CPU calculates the present curvature CC1 based on the white line(s) recognized at Step 505.

It should be noted that a method for calculating a curvature radius R at an arbitrary position on the white line is a well-known. For example, such a method is disclosed in Japanese Patent Application Laid-open No. 2011-169728. The CPU calculates a reciprocal of the calculated curvature radius R as the curvature C.

Subsequently, the CPU determines whether or not a value of a first start flag X1start is “0” at Step 525. The CPU sets the value of the first start flag X1start to “1” when the first start condition becomes satisfied. The CPU sets the value of the first start flag X1start to “0” when a first end condition becomes satisfied. The CPU calculates the first target acceleration AD1tgt in a period from a time point when the first start condition becomes satisfied to a time point when the first end condition becomes satisfied (that is, in a period in which the first situation is occurring). The CPU sets the first start flag X1start to “0” though an initialization routine executed when the driver performs an operation for changing a position of an ignition key switch (now shown) of the vehicle VA from an off-position to an on-position.

When the value of the first start flag X1start is “0” (in other words, when the first start condition has not been satisfied yet), the CPU makes a “Yes” determination at Step 525 to proceed to Step 530.

The CPU determines whether or not the first start condition becomes satisfied at Step 530. More specifically, the CPU determines that the first start condition becomes satisfied when both the following conditions (CA) and (CB) are satisfied.

(CA): The future curvature FC1 calculated at Step 515 is equal to or larger than a first threshold curvature C1th.

(CB): The present curvature CC1 calculated at Step 520 is equal to or smaller than a second threshold curvature C2th which has been set to a value smaller than the first threshold curvature C1th.

When at least one of the conditions (CA) and (CB) is not satisfied, the first start condition is not satisfied. In this case, the CPU makes a “No” determination at Step 530, and proceeds to Step 595 to tentatively terminate the present routine. As a result, the first start condition flag X1start remains “0”.

On the other hand, both the conditions (CA) and (CB) are satisfied, the first start condition become satisfied, and thus, the first situation has been occurring. In this case, the CPU makes a “Yes” determination at Step 530 to proceed to Step 535. The CPU sets the value of the first start flag X1start to “1” at Step 535 to proceed to Step 540.

The CPU determines which the future position belongs to, the first clothoid section KR1 of the curve Cv, the static circle section SC of the curve Cv, or the second clothoid section KR2 of the curve Cv, at Step 540. The CPU calculates the first target acceleration AD1tgt according to the method corresponding to the determination result, and proceeds to Step 595 to tentatively terminate the present routine.

More specifically, the CPU calculates a subtraction value ΔC by subtracting the future curvature FC2 (hereinafter, referred to as “a last time future curvature FC2”) previously calculated last (at the most recent time point) from the future curvature FC1 (hereinafter, referred to as “a present time future curvature FC1”) calculated at the present time point. The last time future curvature FC2 is the future curvature FC1 calculated at Step 515 of the present routine which was executed at a time point which is a predetermined time before the present time point. Furthermore, the CPU determines which the future position belongs to, the first clothoid section KR1, the static circle section SC, or the second clothoid section KR2, using the subtraction value ΔC and according to the following manners (A1), (B1), and (C1).

(A1) When the subtraction value ΔC is larger than a threshold Th1 which has been set to a positive predetermined value, the CPU determines that the future position belongs to (i.e., is within) the first clothoid section KR1.

(B1) When the subtraction value ΔC is equal to or larger than a threshold Th2 which has been set to a negative predetermined value and the subtraction value ΔC is equal to smaller than the threshold Th1, the CPU determines that the future position belongs to (i.e., is within) the static circle section SC.

(C1) When the subtraction value ΔC is smaller than the threshold Th2, the CPU determines that the future position belongs to (i.e., is within) the second clothoid section KR2.

The CPU calculates the first target acceleration AD1tgt according to the determination result determined using the above described manners (A1), (B1), and (C1), as described below.

(A1) A case where the future position is within the first clothoid section KR1 (the first clothoid section KR1 includes the future position).

In this case, the CPU calculates the first target acceleration AD1tgt according to the following equation (2).

First target acceleration AD1tgt=Base acceleration BAD·Gain Ga (2)

The CPU obtains the base acceleration BAD of the equation (2) by applying the vehicle speed Vs to a base acceleration map Map(BAD). According to the base acceleration map Map(BAD), as shown in a block BL1 of FIG. 6, the base acceleration BAD which is a value smaller than “0” becomes smaller, as the vehicle speed Vs becomes higher. In other words, a deceleration represented by the base acceleration BAD becomes greater as the vehicle speed Vs becomes higher.

The CPU calculates the gain Ga of the equation (2) as follows.

Firstly, the CPU obtains the curve target vehicle speed Vctgt by applying the curvature radius R (=1/FC1) corresponding to the future curvature FC1 to a curve target vehicle speed map MapVctgt(R) (referring to a block BL2 of FIG. 6). According to the curve target vehicle speed MapVctgt(R), the curve target vehicle speed Vctgt becomes smaller, as the curvature radius R becomes smaller (in other words, as the curvature C becomes larger).

Next, the CPU calculates a subtraction vehicle speed DVs (DVs=Vs−Vctgt) by subtracting the obtained curve target vehicle speed Vctgt from the vehicle speed Vs.

Next, the CPU obtains the gain Ga by applying the subtraction vehicle speed DVs to a gain map MapGa(DVs) (referring to a block BL3 of FIG. 5). According to the gain map MapGa(DVs), the gain Ga which can be a value equal to or larger than “0” and equal to or smaller than “1” becomes larger, as the subtraction vehicle speed DVs becomes larger. It should be noted that when the subtraction vehicle speed DVs is equal to or smaller than “0” (in other words, when the vehicle speed Vs is equal to or lower than the curve target vehicle speed Vctgt), the vehicle VA is not required to be decelerated. Therefore, when the subtraction vehicle speed DVs is equal to or smaller than “0”, the CPU sets the gain Ga to “0” based on the gain map MapGa(DVs).

Furthermore, when the calculated first target acceleration AD1tgt is smaller than a first threshold acceleration AD1th which has been set to a negative value, the CPU sets the first target acceleration AD1th to the first threshold acceleration AD1th (referring to (C) of FIG. 2). As described above, the actual acceleration dg is controlled based on the first target acceleration AD1tgt through the pre-curve deceleration shown in FIGS. 2 and 3. The CPU executes the pre-curve deceleration in order to inform the driver that the vehicle VA will enter the curve Cv soon. The CPU executes the pre-curve deceleration with a deceleration whose magnitude is equal to or smaller than the magnitude of the first threshold acceleration AD1th. Hereby, the DSECU 10 can decrease the possibility that the sudden/great deceleration causes the driver to feel discomfort.

(B1) A case where the future position is within the static circle section SC (that Is, the static circle section SC includes the future position).

In this case, the CPU sets/calculates the first target acceleration AD1tgt in such a manner that the vehicle VA travels in a uniform circular motion at the constant vehicle speed. That is, the CPU sets the first target acceleration AD1tgt to “0”.

(C1) A case where the future position is within the second clothoid section KR2 (that is, the second clothoid section KR2 includes the future position).

In this case, if the CPU is executing the distance maintaining control, the CPU sets the normal target vehicle speed Vntgt to the vehicle speed of the objective-forward-vehicle (a). The CPU calculates the vehicle speed of the objective-forward-vehicle (a) by adding the vehicle speed Vs to the relative speed Vfx(a) of the objective-forward-vehicle (a). On the other hand, if the CPU is executing the constant speed traveling control, the CPU sets the normal target vehicle speed Vntgt to the target vehicle speed for the constant speed traveling control.

Next, the CPU calculates the first target acceleration AD1tgt in such a manner that the vehicle speed Vs approaches the normal target vehicle speed Vntgt. More specifically, the CPU executes the following processes.

The CPU calculates a subtraction vehicle speed DVs (DVs=Vntgt−Vs) by subtracting the vehicle speed Vs from the normal target vehicle speed Vntgt.

The CPU obtains the first target acceleration AD1tgt by applying the subtraction value DVs and the curvature radius R (=1/FC1) corresponding to the future curvature FC1 to a target acceleration map MapAD1tgt(DVs, R) (not shown). According to the target acceleration map MapAD1tgt (DVs, R), the first target acceleration AD1tgt becomes larger, as the subtraction vehicle speed DVs becomes larger and/or the curvature radius R (=1/FC1) becomes larger. When the subtraction vehicle speed DVs is a negative value (that is, Vntgt<Vs), the CPU sets the first target acceleration AD1tgt to “0” based on the target acceleration map MapAD1tgt(DVs, R).

When the CPU proceeds to Step 525 in the present routine after the CPU has set the value of the first start flag X1start to “1” at Step 535, the CPU makes a “No” determination at Step 525 to proceed to Step 545.

The CPU determines whether or not the first end condition has become satisfied. The first end condition becomes satisfied when the curve Cv in which the vehicle VA is travelling ends. More specifically, the CPU determines that the first end condition has become satisfied when both the following conditions (CC) and (CD) have been satisfied.

(CC): The future curvature FC1 calculated at Step 515 is equal to or smaller than a third threshold curvature C3th.

(CD): The present curvature CC1 calculated at Step 520 is equal to or larger than a fourth threshold curvature C4th which is set to a value larger than the third threshold curvature C3th.

The third threshold curvature C3th may be set to the same value as the second threshold curvature C2th. The fourth threshold curvature C4th may be set to the same value as the first threshold curvature C1th.

When at least one of the conditions (CC) and (CD) has not been satisfied, the first end condition has not become satisfied. In this case, the CPU makes a “No” determination at Step 545, and proceeds to Step 540 to calculate (update) the first target acceleration AD1tgt. Thereafter, the CPU proceeds to Step 595 to tentatively terminate the present routine.

On the other hand, when both of the conditions (CC) and (CD) have been satisfied, the first situation no longer occurs. In this case, the CPU makes a “Yes” determination at Step 545 to proceed to Step 550. The CPU sets the value of the first start flag X1start to “0” at Step 550, and proceeds to Step 595 to tentatively terminate the present routine. As a result, the CPU does not execute the process of Step 540, so that the CPU stops calculating the first target acceleration AD1tgt.

<Second Target Acceleration Calculation Process (Routine Shown in FIG. 6)>

When the CPU proceeds to Step 420 shown in FIG. 4, the CPU starts processes from Step 600 shown in FIG. 6. The processes are included in a subroutine represented by a flowchart shown in FIG. 6. The CPC proceeds to Step 605 to obtain the actual yaw rate Yr from the yaw rate sensor 12, and proceeds to Step 610. In Actuality, the CPU adjusts/modifies the yaw rate Yr obtained from the yaw rate sensor 12 using a zero point adjustment value described later.

The CPU calculates a second reliability degree RD2 indicative of the reliability of the second target acceleration AD2tgt based on an elapsed time from an acquisition time point when the CPU obtained (stored) the zero point adjustment value last (at the most recent time point). The CPU calculates the second reliability degree RD2 in such a manner that the second reliability degree RD2 becomes smaller, as the elapsed time becomes longer. The CPU sets the elapsed time to “0” when the CPU obtains the zero point adjustment value, When the elapsed time from the acquisition time point is “0”, the CPU sets the second reliability degree to the maximum value (e.g. “100”).

A zero point modification process of the yaw rate sensor 12 is a well-known process disclosed in Japanese Patent Application Laid-open No. 2018-127146. For example, the CPU obtains the yaw rate Yr detected by the yaw rate sensor 12 in a state where no yaw rate Yr is applied to the vehicle VA (in other words, in a state where the vehicle speed Vs is “0”) as the zero point adjustment value, and stores the obtained yaw rate Yr. Thereafter, the CPU adjusts/modifies the yaw rate Yr detected by the yaw rate sensor 12 using the zero point adjustment value to adopt/employs (use) the modified value as the actual yaw rate Yr.

At Step 615, the CPU calculates the curvature radius R by applying the actual yaw rate Yr (the yaw rate Yr adjusted/modified using the zero point adjustment value) and the vehicle speed Vs to the following equation (3). Thereafter, the CPU calculates a reciprocal (=1/R) of the calculated curvature radius R as the present curvature CC2. The present curvature CC2 represents the curvature C of the traveling road/lane at the present position of the vehicle VA.

R=Vs/Yr (3)

A process for calculating the curvature radius R based on the yaw rate Yr and the vehicle speed Vs is a well-known process, and is disclosed, for example, in WO 2010/073300.

Next, the CPU proceeds to Step 620 to determine whether or not the value of the second start flag X2start is “0”. The CPU sets the value of the second start flag X2start to “1” when the second start condition becomes satisfied. The CPU sets the value of the second start flag X2start to “0” when a second end condition becomes satisfied. The CPU calculates the second target acceleration AD2tgt in a period from a time point when the second start condition becomes satisfied to a time point when the second end condition becomes satisfied (in other words, while the second situation is occurring). The CPU sets the second start flag X2start to “0” though the initialization routine.

When the value of the second start flag X2start is “0” (in other words, when the second start condition has not been satisfied yet), the CPU makes a “Yes” at Step 620 to proceed to Step 625.

The CPU determines whether or not the second start condition becomes satisfied at Step 625. More specifically, the CPU determines that the second start condition becomes satisfied when all the following conditions (DA), (DB), and (DC) are satisfied.

(DA) The present curvature CC2 calculated at Step 615 is equal to or larger than a fifth threshold curvature C5th.

(DB) A magnitude |LG| of a lateral acceleration LG is equal to or larger than a first threshold lateral acceleration (=LG1th).

(DC) A magnitude |LJ| of a lateral jerk LJ which is a derivative value of the lateral acceleration LG with respect to time is equal to or larger than a first threshold lateral jerk LJth.

The CPU calculates the magnitude |LG| of the lateral acceleration LG by applying the yaw rate Yr and the vehicle speed Vs to the following equation (4). The CPU may use the magnitude |LG| of the lateral acceleration LG detected by the acceleration sensor 16 as the above magnitude |LG|.

|LG|=|Yr*Vs| (4)

When at least one of the conditions (DA), (DB), and (DC) is not satisfied, the second start condition is not satisfied. In this case, the CPU makes a “No” determination at Step 625, and proceeds to Step 695 to tentatively terminate the present routine. As a result, the start flag X2start remains “0”.

On the other hand, when all of the conditions (DA), (DB), and (DC) are satisfied, the second start condition becomes satisfied and thus, the second situation has been occurring. In this case, the CPU makes a “Yes” determination at Step 625 to proceed to Step 630. The CPU sets the value of the second start flag X2start to “1” at Step 630 to proceed to Step 635.

The CPU calculates the second target acceleration AD2tgt at Step 635, and proceeds to Step 695 to tentatively terminate the present routine.

The process of Step 635 will next be described.

The CPU determines which the present position belongs to using the present curvature CC2 instead of the future curvature FC1, the first clothoid section KR1, the static circle section SC, or the second clothoid section KR2.

More specifically, the CPU calculates a subtraction value ΔC by subtracting the present curvature CC2 previously calculated last (at the most recent time point) (in other words, the present curvature CC2 calculated the predetermined time before the present time point) from the present curvature CC2 which is calculated at the present time point. Thereafter, the CPU determines which the present position belongs to, the first clothoid section KR1, the static circle section SC, or the second clothoid section KR2, using the subtraction value ΔC and according to the following manners (A1′), (B1′), and (C1′).

(A1′) When the subtraction value ΔC is larger than the threshold Th1 which has been set to the positive predetermined value, the CPU determines that the present position belongs to (i.e., is within) the first clothoid section KR1.

(B1′) When the subtraction value ΔC is equal to or larger than the threshold Th2 which has been set to the negative predetermined value and the subtraction value ΔC is equal to smaller than the threshold Th1, the CPU determines that the present position belongs to (i.e., is within) the static circle section SC.

(C1′) When the subtraction value ΔC is smaller than the threshold Th2, the CPU determines that the present position belongs to (i.e., is within) the second clothoid section KR2.

Furthermore, as described later, the CPU calculates the second target acceleration AD2tgt according to the determination result (i.e., the section to which the present position belongs, or within which the present position is).

(A1′) A case where the present position is within the first clothoid section KR1 (the first clothoid section KR1 includes the present position).

In this case, the CPU calculates the second target acceleration AD2tgt according to the following equation (5).

AD2tgt=|LJ|·Ga (5)

The CPU calculates the lateral jerk LJ in the same manner as the process of Step 625. Furthermore, the CPU calculates the gain Ga in the same manner as the process of the (A) at Step 540. Note, however, the CPU obtains the curve target vehicle speed Vctgt by applying the curvature radius R (=1/CC2) corresponding to the present curvature CC2 instead of the curvature radius R (=1/FC1) corresponding to the future curvature FC1 to the curve target vehicle speed map MapVctgt(R) (referring to a block BL2′ shown in FIG. 6).

Next, the CPU calculates the subtraction vehicle speed DVs (DVs=Vs−Vctgt) by subtracting the obtained curve target vehicle speed Vctgt from the vehicle speed Vs. Thereafter, the CPU obtains the gain Ga by applying the subtraction vehicle speed DVs to the gain map MapGa(DVs) (referring to a block BL3 shown in FIG. 6).

Furthermore, when the calculated second target acceleration AD2tgt is smaller than a second threshold acceleration AD2th which has been set to a negative value, the CPU sets the second target acceleration AD2tgt to the second threshold acceleration AD2th (referring to (D) shown in FIG. 3). It is preferable that the vehicle speed is made to come closer to the curve target vehicle speed Vctgt earlier (in a shorter time) by the deceleration in the the first clothoid section KR1 so that the vehicle VA can travel the curve stably, unlike the case where the vehicle VA is decelerated through the pre-curve deceleration. Therefore, the second threshold acceleration AD2th has been set to a value which is the negative value and smaller than the first threshold acceleration AD1th.

It should be noted that the CPU may calculate the second target acceleration AD2th according to the above described equation (2), similarly to Step 540 shown in FIG. 5. In this case, however, the CPU uses the curvature radius R (=1/CC2) corresponding to the present curvature 002 instead of the curvature R (=1/FC1) corresponding to the future curvature FC1.

(B1′) A case where the present position is within the static circular section SC (the static circular section SC includes the present position).

In this case, the CPU sets the second target acceleration AD2tgt to “0”, similarly to the above (B1).

(C1′) A case where the present position is within the second clothoid section KR2 (the second clothoid section KR2 includes the present position).

The CPU calculates the second target acceleration AD2tgt in such a manner that the vehicle Vs approaches the normal target vehicle speed Vntgt, similarly to the above described (C1). In this case, however, the CPU uses the curvature radius R (=1/CC2) corresponding to the present curvature CC2 instead of the curvature R (=1/FC1) corresponding to the future curvature FC1.

When the CPU executes the present routine to proceed to Step 620 after the CPU has set the value of the second start flag X2start to “1” at Step 630, the CPU makes a “No” determination at Step 620 to proceed to Step 640.

The CPU determines whether or not the second end condition becomes satisfied at Step 640. The second end condition becomes satisfied when the curve Cv in which the vehicle VA is traveling actually ends. More specifically, when all the following conditions (DD), (DE), and (DF) have been satisfied, the CPU determines that the second end condition has become satisfied.

(DD) The present curvature CC2 calculated at Step 615 is equal to or smaller than a sixth threshold curvature C6th.

(DE) The magnitude |LG| of the lateral acceleration LG is equal to or smaller than a second threshold lateral acceleration LG2th.

(DF) The magnitude |LJ| of the lateral jerk LJ is equal to or smaller than a second threshold lateral jerk LJ2th.

The sixth threshold curvature C6th may be set to the same value as the fifth threshold curvature C5th. The second threshold lateral acceleration LG2th may be set to the same value as the first threshold lateral acceleration LG1th. The second threshold lateral jerk LJ2th may be set to the first threshold lateral jerk LJ1th.

When at least one of the conditions (DD), (DE), and (DF) has not been satisfied, the second end condition has not become satisfied. In this case, the CPU makes a “No” determination at Step 640, and proceeds to Step 635 to calculate (update) the second target acceleration AD2tgt. Thereafter, the CPU proceeds to Step 695 to tentatively terminate the present routine.

On the other hand, when all the conditions (DD), (DE), and (DF) have been satisfied, the CPU can determine that the second situation has not been occurring. In this case, the CPU makes a “Yes” determination at Step 640 to proceed to Step 645. The CPU sets the value of the second start flag X2start to “0” at Step 645, and proceeds to Step 695 to tentatively terminate the present routine. Consequently, the CPU does not execute the process of Step 635, in other words, calculating the second target acceleration AD2tgt is stopped.

<SPM Final Target Acceleration Determination Process (a Routine Shown in FIG. 7)>

When the CPU proceeds to Step 425 shown in FIG. 4, the CPU starts processes from Step 700 shown in FIG. 7. The processes are included in a subroutine represented by a flowchart shown in FIG. 7. The CPU proceeds to Step 705.

At Step 705. The CPU determines whether or not both of the values of the first start flag X1start and the second start flag X2start are “0”. In other words, the CPU determines whether or not the CPU has been calculating neither the first target acceleration AD1tgt nor the second target acceleration AD2tgt. When both of the values of the first start flag X1start and the second start flag X2start are “0”, the CPU makes a “Yes” determination at Step 705, and proceeds to Step 710 to set the SPM final target acceleration ADFtgt to a predetermined invalid value (Null). Subsequently, the CPU proceeds to Step 795 to tentatively terminate the present routine. In this case, as described above, when the CPU proceeds to Step 435 shown in FIG. 4, the CPU transmits the ACC target acceleration GACCtgt as the driving support target acceleration GStgt to the engine ECU 20 and the brake ECU 30. Accordingly, the speed management control is not executed substantially.

On the other hand, when at least one of the values of the first start flag X1start and the second start flag X2start is “1”, the CPU makes a “No” determination at Step 705, and proceeds to Step 715 to determine whether or not both of the values of the first start flag X1start and the second start flag X2start are “1”. In other words, the CPU determines whether or not both of the first situation and the second situation have been occurring.

When both of the values of the first start flag X1start and the second start flag X2start are “1”, the CPU employs/chooses the second target acceleration AD2tgt preferentially as the SPM final target acceleration ADFtgt between the second target acceleration AD2tgt and the first target acceleration AD1tgt. In other words, the second target acceleration AD2tgt has a higher priority to be chosen than the first target acceleration AD1tgt. Accordingly, in this case, the CPU makes a “Yes” determination at Step 715, and proceeds to Step 720 to determine whether or not the second reliability degree RD2 is equal to or larger than a second threshold reliability degree RD2th.

When the second reliability degree RD2 is equal to or larger than the second threshold reliability degree RD2th, the CPU makes a “Yes” determination at Step 720, and proceeds to Step 725 to set the SPM final target acceleration ADFtgt to the second target acceleration AD2tgt. Subsequently, the CPU proceeds to Step 795 to tentatively terminate the present routine.

When only one of the first start flag X1start and the second start flag X2start is “0” at a time point when the CPU proceeds to Step 715, the CPU makes a “No” determination at Step 715 to proceed to Step 730. At Step 730, the CPU determines whether or not a condition that the value of the first start flag X1start is “1” and the value of the second start flag X2start is “0” is satisfied. In other words, the CPU determines whether or not only the first situation has been occurring.

When the condition that the value of the first start flag X1start is “1” and the value of the second start flag X2start is “0” is satisfied, the CPU makes a “Yes” determination at Step 730, and proceeds to Step 735 to determine whether or not the first reliability degree RD1 is equal to larger than the first reliability degree RD1th.

When the first reliability degree RD1 is equal to or larger than the first reliability degree RD1th, the CPU makes a “Yes” determination at Step 735, and proceeds to Step 740 to set the SPM final target acceleration ADFtgt to the first target acceleration AD1tgt. Subsequently, the CPU proceeds to Step 795 to tentatively terminate the present routine.

On the other hand, when the first reliability degree RD1 is smaller than the first threshold reliability degree RD1th, the CPU makes a “No” determination at Step 735, and proceeds to Step 745 to set the SPM final target acceleration ADFtgt to the predetermined invalid value (Null). Subsequently, the CPU proceeds to Step 795 to tentatively terminate the present routine.

When the condition used at Step 730 are not satisfied (in other words, when the value of the first start flag X1start is “0” and the value of the second start flag X2start is “1”) at the time point when the CPU proceeds to Step 730, the CPU makes a “No” determination at Step 730 to proceeds to Step 750. In this case, the value of the first start flag X1start is “0” and the value of the second start flag X2start is “1”. Therefore, only the second target acceleration AD2tgt between the first target acceleration AD1tgt and the second target acceleration AD2tgt has been calculated. For example, such a situation occurs when the CPU cannot obtain the camera image for some reasons.

At Step 750, the CPU determines whether or not the second reliability degree RD2 is equal to or larger than the second threshold reliability degree RD2th. When the second reliability degree RD2 is equal to or larger than the second threshold reliability degree RD2th, the CPU makes a “Yes” determination at Step 750, and proceeds to Step 755 to set the SPM final target acceleration ADFtgt to the second target acceleration AD2tgt. Subsequently, the CPU proceeds to Step 795 to tentatively terminate the present routine.

On the other hand, when the second reliability degree RD2 is smaller than the second threshold reliability degree RD2th, the CPU makes a “No” determination at Step 750, and proceeds to Step 755 to set the final SPM target acceleration ADFtgt to the predetermined value (Null). Subsequently, the CPU proceeds to Step 795 to tentatively terminate the present routine.

It should be noted that, when the second reliability degree RD2 is smaller than the second threshold reliability degree RD2th at the time point when the CPU proceeds to Step 720, the CPU makes a “No” determination at Step 720 to proceed to Step 735.

<Gradual Change Process (a Routine Shown in FIG. 8)>

When the CPU proceeds to Step 430 shown in FIG. 4, the CPU starts processes from Step 800 shown in FIG. 8. The processes are included in a subroutine represented by a flowchart shown in FIG. 8. The CPU proceeds to Step 805.

At Step 805, the CPU determines whether or not a value of a gradual change flag Xjohen is “0”. The CPU sets the value of the gradual change flag Xjohen to “1” at Step 820 described later, and sets that value to “0” at Step 845 described later. Furthermore, the CPU sets the value of the gradual change flag Xjohen to “0” through the initialization routine executed by the CPU.

When the value of the gradual change flag Xjohen is “0”, the CPU makes a “Yes” determination at Step 805 to proceed to Step 810. At Step 810, the CPU determines whether or not both of the following conditions (EA) and (EB) have been satisfied. That is, the CPU determines whether or not the SPM final target acceleration ADFtgt has switched between the first target acceleration AD1tgt and the second target acceleration AD2tgt.

(EA) The SPM final target acceleration ADFtgt at a time point when the CPU executed the present routine last time was one acceleration between the first target acceleration AD1tgt and the second target acceleration AD2tgt.

(EB) The SPM final target acceleration ADFtgt at a time point when the CPU executes the present routine this time is the other acceleration between the first target acceleration AD1tgt and the second target acceleration AD2tgt.

When both the conditions (EA) and (EB) have not been satisfied at the same time, the CPU makes a “No” determination at Step 810, and proceed to Step 815. At Step 815, the CPU stores the SPM final target acceleration ADFtgt at the present time point, which has been determined/set through the routine shown in FIG. 7, as a pre-switch SPM final target acceleration ADFold. Subsequently, the CPU proceeds to Step 895 to tentatively terminate the present routine.

When both of the conditions (EA) and (EB) have been satisfied at the same time, the CPU makes a “Yes” determination at Step 810, and executes the following processes from Step 820 to Step 835 in order.

Step 820: The CPU sets the value of the gradual change flag Xjohen to “1”.

Step 825: The CPU sets a value of a timer T to “0” (that is, the CPU initializes the timer T).

Step 830: The CPU increases the value of the timer T by “1”. Accordingly, the value of the timer T represents an elapsed time from a switch time point when the SPM final target acceleration ADFtgt changes over between the first target acceleration AD1tgt and the second target acceleration AD2tgt.

When the value of the timer T is smaller than a threshold Tth, the CPU makes a “Yes” determination at Step 835 to proceed to Step 840. “A time period from the switch time point to a time point when the value of the timer T becomes equal to the threshold Tth” may be referred to as “a gradual change time period” or “a transition time period”. At Step 840, the CPU calculates “the SPM final target acceleration ADFtgt (referred to as “AGC ADFtgt”) after the gradual change process” according to the following equation (6). The “ADFold” included in the right side of the equation (6) is the SPM final acceleration ADFtgt stored (obtained) at Step 815. In other words, the “ADFold” is the SPM final target acceleration ADFtgt immediately before the switch time point. The “ADFtgt” included in the right side of the equation (6) is “the SPM final target acceleration ADFtgt at the present time point” which has been set/determined through the routine shown in FIG. 7.

AGC ADFtgt=(1−k)·ADFold+k·ADFtgt (6)

The “k” in the equation (6) is a gradual change coefficient (a weight coefficient). The CPU calculates the gradual change coefficient k by applying the value of the timer T to a gradual change coefficient map Mapk(T) shown in a box of Step 840 of FIG. 8. According to the gradual change coefficient map Mapk(T), the gradual change coefficient k becomes closer to “0”, as the value of the timer T becomes smaller, and the gradual change coefficient k becomes closer to “1”, as the value of the timer T becomes larger.

Accordingly, a weight of the SPM final target acceleration ADFtgt immediately before the switch point becomes smaller (lighter) gradually and a weight of the SPM final target acceleration ADFtgt after the switch time point becomes larger (heavier) gradually, as the value of the timer T become larger.

Thus, for example, assuming that the SPM final target acceleration ADFtgt switches from the first target acceleration AD1tgt to the second target acceleration AD2tgt at the switch time point, the SPM final target acceleration ADFtgt vanes from the first target acceleration AD1tgt to the second target acceleration AD2tgt gradually (smoothly) after the switch time point. Such a change/variation of the SPM final target acceleration ADFtgt prevents a value of the SPM final target acceleration ADFtgt from changing suddenly and greatly immediately after the switch time point. Therefore, the possibility of causing the driver to feel discomfort can be lowered.

When the CPU proceeds to Step 805 of the present routine after the CPU has set the value of the gradual change flag Xjohen to “1” at Step 820, the CPU makes a “No” determination at Step 805 to proceed to Step 830.

When the CPU proceeds to Step 835 of the present routine after the value of the timer T has reached a value equal to or larger than the threshold Tth through increasing the value of the timer T by “1” at Step 830, the CPU makes a “No” determination at Step 835 to proceed to Step 845. At Step 845, the CPU sets the value of the gradual change flag Xjohen to “0”, and proceeds to Step 895 to tentatively terminate the present routine.

As described above, the magnitude of the difference between the second target acceleration AD2tgt and the ideal acceleration is smaller than the magnitude of the difference between the first target acceleration AD1tgt and the ideal acceleration. When both of the first situation and the second situation have been occurring (that is, when a situation in which both of the first target acceleration AD1tgt and the second target acceleration AD2tgt can be calculated has been occurring), the present control device controls the vehicle VA such that the actual acceleration of the vehicle VA approaches the second target acceleration AD2tgt (rather than the first target acceleration AD1tgt). Such a control of the vehicle VA can decrease/lower a possibility that the vehicle VA travels at an unsuitable target acceleration for the curve. Therefore, the present control device can reduce/lower the possibility of causing the driver to feel the discomfort.

The present disclosure is not limited to the above described embodiment, and can adopt various modifications within a scope of the present disclosure.

### FIRST MODIFICATION EXAMPLE

The CPU according to the above described embodiment continues calculating both of the first target acceleration AD1tgt and the second target acceleration AD2tgt from/after the switch time point when the second start condition becomes satisfied while the first start condition has been satisfied (in other words, when the second situation occurs while the first situation has been occurring). In contrast, the CPU according to the first modification example stops calculating the first target acceleration AD1tgt, and starts and continues calculating the second target acceleration AD2tgt when and after the second situation occurs while the first situation has been occurring. That is, when the situation in which both of the first target acceleration AD1tgt and the second target acceleration AD2tgt can be calculated are occurring (in other words, when both of the first situation and the second situation are occurring), the CPU continues calculating the target acceleration with a higher priority (in the above example, the second target acceleration AD2tgt) and stops calculating the other target acceleration with a lower priority (in the above example, the first target acceleration AD1tgt).

In the first modification example, the CPU determines whether or not the value of the second start flag X2start is “1” at Step 545 shown in FIG. 5, When the value of the second start flag X2start is “0”, the CPU proceeds from Step 545 to Step 540 shown in FIG. 5. In contrast, when the value of the second start flag X2start is “1”, the CPU proceeds from Step 545 to Step 550. Hereby, the CPU executes the process of Step 540, only if necessary. Therefore, a calculation load on the CPU can be reduced.

### SECOND MODIFICATION EXAMPLE

The CPU according to the second modification example executes the gradual change process during the transition time period according to the following equation (7). That transition time period starts from the time point when the CPU switches the SPM final target acceleration ADFtgt from the first target acceleration AD1tgt to the second target acceleration AD2tgt. Namely, the transition time period starts when the second situation occurs while the first situation has been occurring, and thus, both of the first situation and the second situation have occurred.

AGC ADFtgt=(1−k)·AD1tgt+k·AD2tgt (7)

In the transition period, both of the first situation and the second situation have been occurring, and therefore, the CPU calculates/updates both of the first target acceleration AD1tgt and the second target acceleration AD2tgt every time the CPU executes the routine shown in FIG. 4. The CPU executes the gradual change process using both of the thus updated first target acceleration AD1tgt and the thus updated second target acceleration AD2tgt.

In the present modification example, the CPU may stop calculating the first target acceleration AD1tgt after the second situation has occurred while the first situation has been occurring. However, the CPU continues calculating both of the first target acceleration AD1tgt and the second target acceleration AD2tgt during the transition time period in order to be able to execute the gradual change process according to the above equation (7). When the transition time period has elapsed, the CPU stops calculating the first target acceleration AD1tgt (the target acceleration with the lower priority) and continues calculating the second target acceleration AD2tgt (the target acceleration with higher priority). In this case, the CPU determines whether or not a calculation end condition described later is satisfied at step 545 shown in FIG. 5. When the calculation end condition is satisfied at step 545 shown in FIG. 5, the CPU proceeds to Step 550. The calculation end condition is satisfied when both of the values of the first start flag X1start and the second start flag X2start have been set to “1”, and the value of the gradual change flag Xjohen has changed from “1” to “0”. On the other hand, when the calculation end condition has not been satisfied, the CPU proceeds to Step 540.

### THIRD MODIFICATION EXAMPLE

The vehicle control device (hereinafter, referred to as a third modification device) according to a third modification example adopts/employs a navigation method as the first method for calculating the first target acceleration AD1tgt. The third modification device comprises the navigation system 17 and the GPS receiver 18 (referring to FIG. 1).

The navigation system 17 has stored map data (navigation information) including a position of the curve Cv on the earth's surface, the curvature of the curve Cv, and the like in advance.

The GPS receiver 18 receives GPS signals from GPS satellites, every time a predetermined elapses. The GPS receiver 18 specifies/identifies the present position of the vehicle VA on the earth's surface based on the received GPS signals. Subsequently, the CPU transmits a position signal enabling the DSECU 10 to specify/identify the present position of the vehicle VA to the DSECU 10. It should be noted that the position signal includes the number of the GPS satellites which transmitted the GPS signals which the GPS receiver 18 has successfully received.

The CPU of the DSECU 10 of the third modification device executes the substantially same routines as the above described routines executed by the CPU of the above described embodiment device. Note, however that, when executing the process of Step 415 shown in FIG. 4, the CPU of the DSECU 10 of the third modification device executes a third modification example routine which is the same routine as the routine shown in FIG. 5 except that Step 505 shown in FIG. 5 is omitted and Steps 510 through 520 shown in FIG. 5 are changed as follows.

When the CPU proceeds to Step 415 shown in FIG. 4, the CPU starts processes of the third modification example routine from Step 500, and proceeds to Step 510 to determine the first reliability degree RD1 based on the number of the GPS satellites included in the position signal transmitted from the GPS receiver 18. The first reliability degree RD1 is larger, as the number of the GPS satellites is larger.

Subsequently, the CPU proceeds to Step 515 to obtain the curvature of the traveling road at the future position a predetermined distance away from the present position of the vehicle VA in the travel direction as the future curvature FC1, through referring to the map data (the navigation information) of the navigation system 17.

Subsequently, the CPU proceeds to Step 520 to obtain the curvature of the traveling road at the present position of the vehicle VA as the present curvature CC1, through referring to the map data (the navigation information).

In the above manner, the third modification device obtains the first information using the map data (the navigation information) including information on the road shape, and calculates the first target acceleration AD1tgt based on the obtained first information. A magnitude of the difference between the curvature included in the map data and the actual curvature is sometimes large. Furthermore, a magnitude of the difference between the present position of the vehicle VA and the actual position of the vehicle VA is sometimes large. Therefore, in the third modification device, the higher priority is given to the second target acceleration AD2tgt than the first target acceleration AD1tgt.

### FOURTH MODIFICATION EXAMPLE

The vehicle control device (referred to as a fourth modification device) according to a fourth modification example adopts/employs a sign (road sign) recognition method as the first method for calculating the first target acceleration AD1tgt.

The CPU of the DSECU 10 of the fourth modification device executes the substantially same routines as the above described routines executed by the CPU of the above described embodiment device. Note, however, that when executing the process of Step 415 shown in FIG. 4, the CPU of the DSECU 10 of the fourth modification device executes a fourth modification example routine which is the same routine as the routine shown in FIG. 5 except that Steps 510 and 520 shown in FIG. 5 are omitted and Steps 505, 515, 530 and 545 shown in FIG. 5 are changed as follows.

When the CPU proceeds to Step 415 shown in FIG. 4, the CPU starts processes of the fourth modification example routine from Step 500, and proceeds to Step 505 to extract an image (hereinafter, referred to as “an alert sign image”) corresponding to a curve alert road sign from the camera image.

Subsequently, the CPU proceeds to Step 515 without proceeding to Step 510 to recognize a numeral which is painted at an under part of the curve alert sign. The numeral indicates the curvature radius R of the static circular section SC of the curve Cv. The CPU obtains the curvature C based on the curvature radius R indicated by the recognized numeral, as the future curvature FC1.

Subsequently, the CPU proceeds to Step 525 without proceeding to Step 520. When the CPU makes a “Yes” determination at Step 525, the CPU proceeds to Step 530. At Step 530, the CPU determines that the first start condition becomes satisfied when a distance between the vehicle VA and the curve alert sign becomes equal to or shorter than a predetermined distance.

On the other hand, when the CPU makes a “No” determination at Step 525, the CPU proceeds to Step 545. At Step 545, the CPU determines that the first end condition becomes satisfied when the second start condition becomes satisfied.

In the fourth modification, the CPU does not execute the process of Step 510, so that the CPU does not determine/obtain the first reliability degree RD1. Therefore, when the CPU proceeds to Step 425 shown in FIG. 4, the CPU executes a routine which is the same as the routine shown in FIG. 7 except that Step 735 is omitted. That is, when the CPU makes a “Yes” determination at Step 730, the CPU proceeds to Step 740 directly.

### FIFTH MODIFICATION EXAMPLE

The vehicle control device (hereinafter, referred to as a fifth modification device) according to a fifth modification example adopts/employs a vehicle ahead (target vehicle) travel history method, as the first method for calculating the first target acceleration AD1tgt.

The CPU of the DSECU 10 of the fifth modification device executes the substantially same routines as the above described routines executed by the CPU of the above described embodiment device. Note, however, that when executing the process of Step 415 shown in FIG. 4, the CPU executes a fifth modification example routine which is the same routine as the routine shown in FIG. 5 except that Step 510 shown in FIG. 5 is omitted and Steps 505 through 520 shown in FIG. 5 are changed as follows.

When the CPU proceeds to Step 415 shown in FIG. 4, the CPU starts processes of the fifth modification example routine from Step 500, and proceeds to Step 505 to specify a position of the objective-forward-vehicle (a) in relation to the vehicle VA. When the CPU detects no objective-forward-vehicle (a), the CPU cannot calculate the first target acceleration AD1tgt. Therefore, in this case, the CPU tentatively terminates the fifth modification example routine.

Subsequently, the CPU proceeds to Step 515 without proceeding to Step 510 to calculate the future curvature FC1 based on a history of the positions of the objective-forward-vehicle (a) in relation to the vehicle VA. After the objective-forward-vehicle (a) enters the curve Cv, the objective-forward-vehicle (a) travels along the curve. Therefore, the CPU calculates the future curvature FC1 based on a curvature of a line segment connecting the positions of the objective-forward-vehicle (a).

Subsequently, the CPU calculates the present curvature CC1 based on the history of the positions of the objective-forward-vehicle (a) in relation to the vehicle VA at Step 520.

In the fifth modification, the CPU does not execute the process of Step 510, so that the CPU does not determine/obtain the first reliability degree RD1. Therefore, when the CPU proceeds to Step 425 shown in FIG. 4, the CPU executes a routine which is the same routine as the routine shown in FIG. 7 except that Step 735 is omitted. That is, when the CPU makes a “Yes” determination at Step 730, the CPU proceeds to Step 740 directly.

### SIXTH MODIFICATION EXAMPLE

The vehicle control device (referred to as a sixth modification device) according to a sixth modification example adopts/employs a steering angle method as the second method for calculating the second target acceleration AD2tgt. As described above, the sixth modification device comprises the steering angle sensor 19 (referring to FIG. 1). The steering angle sensor 19 detects a steering angle of a steering wheel (not shown) of the vehicle VA to transmit a steering angle signal indicative of the detected steering angle to the DSECU 10.

The CPU of the DSECU 10 of the sixth modification device executes the substantially same routines as the above described routines executed by the CPU of the above described embodiment device. Note, however, that when executing the process of Step 420 shown in FIG. 4, the CPU of the DSECU 10 of the sixth modification device executes a sixth modification example routine which is the same routine as the routine shown in FIG. 6 except that Steps 605 through 615 shown in FIG. 6 are changed as follows.

When the CPU proceeds to Step 420 shown in FIG. 4, the CPU starts processes of the sixth modification example routine from Step 600, and proceeds to Step 605 to calculate the yaw rate Yr based on “the steering angle represented by the steering angle signal transmitted from the steering angle sensor 19” and the vehicle speed Vs.

Subsequently, the CPU proceeds to Step 610 to calculate the present curvature CC2 based on the yaw rate Yr calculated at Step 605, and proceeds to Step 615.

When the vehicle VA stops (is not moving), the DSECU 10 makes the zero point adjustment on not only the yaw rate but also the steering angle. Therefore, at Step 615, the CPU obtains the second reliability degree RD2 using the same manner as one at Step 615 shown in FIG. 6 executed by the CPU of the above described embodiment device.

### SEVENTH MODIFICATION EXAMPLE

The vehicle control device (referred to as a seventh modification device) according to a seventh modification example adopts/employs an acceleration method as the second method for calculating the second target acceleration AD2tgt.

The CPU of the DSECU 10 of the seventh modification device executes the substantially same routines as the above described routines executed by the CPU of the above described embodiment device. Note, however, that when the CPU of the DSECU 10 of the seventh modification device proceeds to Step 420 shown in FIG. 4, the CPU executes a seventh modification example routine which is the same routine as the routine shown in FIG. 6 except that Steps 605 through 615 shown in FIG. 6 are changed as follows.

When the CPU proceeds to Step 420 shown in FIG. 4, the CPU starts processes of the seventh modification example routine from Step 600, and proceeds to Step 605 to calculate the yaw rate Yr based on “a lateral acceleration LG indicated by an acceleration signal transmitted from the acceleration sensor 16” and the vehicle speed Vs.

Subsequently, the CPU proceeds to Step 610 to calculate the present curvature CC2 based on the yaw rate Yr calculated at Step 605, and proceeds to Step 615.

When the vehicle VA stops (is not moving), the DSECU 10 makes the zero point adjustment on not only the yaw rate but also the acceleration detected by the acceleration sensor 16. Japanese Patent Application Laid-open No. 2009-264794 discloses the zero point adjustment process on the acceleration. Accordingly, the description of the zero point adjustment process on the acceleration is omitted. At Step 615, the CPU determines/obtains the second reliability degree RD2 using the same manner as one used at Step 615 shown in FIG. 6 executed by the CPU of the above described embodiment device.

Each of the yaw rate Yr used in the yaw rate method, the steering angle used in the steering angle method, and the lateral acceleration LG used in the acceleration method is present information including a physical value regarding a turning movement of the vehicle VA, which is detected by one of various sensors at the present time point. The second method is required to use such information, and is not limited to the above methods.

When a stereo camera device which can measure a distance to the obstacle is adopted/employed as the camera device 13, the above described vehicle control device does not have to comprise the millimeter wave radar device 14.

The millimeter wave radar device 14 may be any device/sensor which transmits/emits a wireless medium to detect the obstacle by receiving a reflected wireless medium by the obstacle.

At Steps 625 and 635 shown in FIG. 6, the CPU calculates the lateral acceleration LG based on the yaw rate Yr and the vehicle speed Vs. In some embodiments, the CPU may obtain the lateral acceleration LG detected by the acceleration sensor 16.

The CPU needs not to execute the process (the gradual change process) of Step 430 in the routine shown in FIG. 4.

The above described vehicle control device needs not to execute at least one of the constant speed traveling control and the distance maintaining control.

When the CPU determines that the present position of the vehicle VA is within (belongs to) the second clothoid section KR2 at Step 635 of the routine shown in FIG. 6, the CPU may calculate the second target acceleration AD2tgt such that the vehicle speed Vs increases gradually to “the vehicle speed Vs at a time point when the vehicle VA entered the first clothoid section KR1 (at a time point immediately before executing the speed management)”.

At Step 540 of the routine shown in FIG. 5, the CPU does not necessarily calculate the first target acceleration AD1tgt for the future position of the vehicle VA belonging to the static circle section SC to be “0”. For example, that first target acceleration AD1tgt may be a positive constant value corresponding to the curvature of the static circle section SC.

At Step 625 of the routine shown in FIG. 6, the CPU does not necessarily calculate the second target acceleration AD2tgt for the present position of the vehicle VA belonging to the static circle section SC to be “0”. For example, that second target acceleration AD2tgt may be a positive constant value corresponding to the curvature of the static circle section SC.

What is claimed is:

1. A vehicle control device comprising;
a first sensor configured to obtain first information on a road shape of a traveling road on which a vehicle is traveling;
a second sensor configured to obtain second information on the road shape separately from the first sensor; and
a control device configured to:
calculate a first target acceleration which is a target acceleration used when the vehicle travels in a curved section of the traveling road based on the first information, in a case where a first situation has been occurring, wherein the first situation occurs when the first information indicates that the traveling road is in the curved section;
calculate a second target acceleration which is a target acceleration used when the vehicle travels in the curved section of the traveling road based on the second information, in a case where a second situation has been occurring, wherein the second situation occurs when the second information indicates that the traveling road is in the curved section;
control the vehicle, when only either one situation of the first situation and the second situation has been occurring, such that an actual acceleration of the vehicle approaches one of the target accelerations which is calculated when the only either one situation has been occurring; and
control the vehicle, when both situations of the first situation and the second situation have been occurring, such that the actual acceleration approaches a higher priority target acceleration with a higher priority between the first target acceleration and the second target acceleration.

2. The vehicle control device according to claim 1, wherein
the first sensor is configured to obtain image data by photographing an front area ahead of the vehicle to obtain the first information using the obtained image data,
the second sensor is configured to detect a physical value indicative of a movement state of the vehicle to obtain the second information using the detected physical value, and
the control device is configured to have set priorities of the first target acceleration and the second target acceleration such that the priority of the second target acceleration is higher than the priority of the first target acceleration.

3. The vehicle control device according to claim 1, wherein
the first sensor is configured to obtain the first information using map data including information on the road shape,
the second sensor is configured to detect a physical value indicative of a movement state of the vehicle to obtain the second information using the detected physical value, and
the control device is configured to have set priorities of the first target acceleration and the second target acceleration such that the priority of the second target acceleration is higher than the priority of the first target acceleration.

4. The vehicle control device according to claim 2, wherein
the first sensor is configured to obtain information on the road shape of the traveling road at a position a predetermined distance away from a present position of the vehicle as the first information, and
the second sensor is configured to obtain information on the road shape of the traveling road at the present position as the second information.

5. The vehicle control device according to claim 4,
wherein the control device is configured to:
calculate the first target acceleration when only the first situation between the first situation and the second situation has been occurring; and
stop calculating the first target acceleration and calculate the second target acceleration when both of the first situation and the second situation have been occurring.

6. The vehicle control device according to claim 1,
wherein the control device is configured to:
calculate a transition time period target acceleration by making a weight of one target acceleration, which the actual acceleration is controlled to approach immediately before a switch time point, between the first target acceleration and the second target acceleration smaller and making a weight of the other target acceleration larger, as an elapsed time from the switch time point becomes longer, during a transition time period from the switch time point to a time point at which a predetermined time period elapses from the switch time point,
the switch time point being a time point at which a control state is switched from a first state where the actual acceleration is controlled to approach the one target acceleration to a second state where the actual acceleration is controlled to approach the other target acceleration; and
control the vehicle such that the actual acceleration approaches the transition time period target acceleration during the transition time period.

7. The vehicle control device according to claim 1,
wherein the control device is configured to:
calculate a first reliability degree indicative of a reliability degree of the first target acceleration;
calculate a second reliability degree indicative of a reliability degree of the second target acceleration;
control the vehicle such that the actual acceleration approaches the higher priority target acceleration between the first target acceleration and the second target acceleration, when the reliability degree of the higher priority target acceleration is equal to or higher than a first threshold reliability degree in the case where both of the first situation and the second situation have been occurring; and
control the vehicle such that the actual acceleration approaches a lower priority target acceleration other than the higher priority target acceleration between the first target acceleration and the second target acceleration, when the reliability degree of the higher priority target acceleration is lower than the first threshold reliability degree, and the reliability degree of the lower priority target acceleration is equal to or higher than a second threshold reliability degree in the case where both of the first situation and the second situation have been occurring.
